(19) United States
(12) Patent Application Publication
(10) Pub. No.: US 2009/0031741 A1
(43) Pub. Date: Feb. 5, 2009

(54) Automotive air conditioner and method for controlling automotive air conditioner

(75) Inventors: Kosuke Hara, Tokyo (JP); Hirotoshi Iwasaki, Kawasaki-city (JP); Hiroshi Takeda, Nagoya-city (JP); Yasufumi Kojima, Gifu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/218,735

(22) Filed: Jul. 17, 2008

(30) Foreign Application Priority Data
Jul. 20, 2007 (JP) 2007-189908
Jun. 10, 2008 (JP) 2008-152329

(51) Int. Cl. B60H 1/32; G05B 15/00

(52) U.S. Cl. 62/239; 700/276

(57) ABSTRACT

An automotive air conditioner comprises: an air-conditioning unit for supplying conditioned air into a passenger compartment of a vehicle; an information acquiring unit for acquiring state information indicating a state relating to the vehicle; an air conditioning state estimating unit for estimating an air conditioning state inside the passenger compartment that would be achieved after a predetermined time if a setting operation for improving fuel economy were performed based on the state information; a recommended operation determining unit for recommending the setting operation if it is determined that the estimated air conditioning state satisfies a comfort condition that would make the passenger compartment comfortable for an occupant; and an air-conditioning control unit for controlling the air-conditioning unit in accordance with the recommended setting operation.

The Applicant claims the right to priority based on Japanese Patent Application JP 2007-189908, filed on Jul. 20, 2007 and Japanese Patent Application JP 2008-152329, filed on Jun. 10, 2008, and the entire contents of JP 2007-189908 and JP 2008-152329 are hereby incorporated by reference.

### FIELD OF THE INVENTION

The present invention relates to an automotive air conditioner and a method for controlling the automotive air conditioner, and more particularly to an automotive air conditioner that improves fuel economy and a method for controlling such an automotive air conditioner.

### BACKGROUND OF THE INVENTION

Generally, an automotive air conditioner automatically determines the temperature, airflow level, etc., of conditioned air discharged from selected air outlets by reference to various parameters such as temperature setting, outside temperature, inside temperature, and solar radiation. However, human sensitivity to temperature differs from one person to another (some are sensitive to heat, while others are sensitive to cold). As a result, the automatically determined temperature, airflow level, etc., of the conditioned air may not be optimum for every occupant. In that case, an occupant may adjust the temperature setting, airflow level, etc. by operating the operation panel of the air conditioner. If such setting operation has to be performed often, the occupant may find it troublesome. In view of this, an apparatus that optimizes the setting of an air conditioner, etc. so as to match the occupant's preference or an apparatus that simplifies the setting operation has been developed (refer to Japanese Unexamined Patent Publication Nos. H04-243617 and 2000-127869).

The air conditioner disclosed in Japanese Unexamined Patent Publication No. H04-243617 optimizes air conditioning control so as to match the occupant's preference by referring to the air conditioning state, etc. each time the air conditioner setting is changed and correcting, using fussy logic, a data table that carries information for the air conditioning control.

On the other hand, the automatic control system disclosed in Japanese Unexamined Patent Publication No. 2000-127869 acquires some kind of trigger information such as the approach of a given object, and presents the occupant with an automatic control operation (for example, switching the air conditioner to inside air circulation mode or outside air inlet mode, setting the audio to traffic information radio, or stopping the wipers) associated with the trigger information. The occupant need only operate the YES button to the presented automatic control operation, whereupon the automatic control system carries out the operation automatically.

Further, Japanese Unexamined Patent Publication No. 2002-248933 discloses an automotive air conditioner that operates the compressor of the heat pump intermittently according to the temperature of the evaporator, thereby reducing fuel consumption while, at the same time, alleviating the discomfort that the unpleasant odor components adhering to the evaporator gives the occupant.

On the other hand, with increasing interest in environmental protection in recent years, there has also developed a need to reduce energy consumption as much as possible in automotive air conditioners. For this purpose, it is desirable to correct the air conditioner setting as appropriate in such a manner that fuel economy improves. To improve fuel economy without compromising passenger compartment comfort, operations such as adjusting the temperature setting, regulating the airflow level, opening or closing the windows, etc. have to be performed frequently. However, since performing such setting operation frequently is troublesome for the occupant, as earlier described, the setting operation for improving fuel economy is not widely practiced. Further, since neither the apparatus disclosed in Japanese Unexamined Patent Publication No. H04-243617 nor the apparatus disclosed in Japanese Unexamined Patent Publication No. 2000-127869 is intended to improve fuel economy, no proposals have been made therein to correct settings so as to improve fuel economy or to urge the occupant to make such settings.

The automotive air conditioner disclosed in Japanese Unexamined Patent Publication No. 2002-248933 aims to improve fuel economy by operating the air conditioner intermittently, but this air conditioner does not take into account the degree of discomfort that the occupant may feel due to temperature. Furthermore, the air conditioner does not take into account the fact that the degree of discomfort felt due to temperature and odors varies from one occupant to another.

### SUMMARY OF THE INVENTION

An object of the present invention is to provide an automotive air conditioner that can improve fuel economy while maintaining the passenger compartment in a comfortable condition, and a method for controlling such an automotive air conditioner.

According to one aspect of the present invention, there is provided an automotive air conditioner. The automotive air conditioner comprises: an air-conditioning unit for supplying conditioned air into a passenger compartment of a vehicle; an information acquiring unit for acquiring state information indicating a state relating to the vehicle; an air conditioning state estimating unit for estimating an air conditioning state inside the passenger compartment that would be achieved after a predetermined time if a setting operation for improving fuel economy were performed based on the state information; a recommended operation determining unit for recommending the setting operation if it is determined that the estimated air conditioning state satisfies a comfort condition that would make the passenger compartment comfortable for an occupant; and an air-conditioning control unit for controlling the air-conditioning unit in accordance with the recommended setting operation.

With the above configuration, the automotive air conditioner can improve fuel economy while maintaining the passenger compartment in a comfortable condition. In this patent specification, the state information refers to information indicating the state relating to the vehicle, which includes, for example, air conditioning information inside and outside the vehicle, vehicle location information, vehicle behavior information, time information, physiological information concerning vehicle occupants, etc. The setting operation refers to an operation for changing the operation state of the automotive air conditioner, such as changing the set temperature, changing the airflow level, setting the air inlet mode to the inside air circulation mode, starting or stopping the defroster, etc. Further, the information that defines the operation of the automotive air conditioner, and that is corrected in accordance with the setting operation, is referred to as the setting information. The setting information includes, for example, the set temperature, the airflow level, the inside/outside air ratio, the airflow ratio of conditioned air between various air outlets.

Preferably, the automotive air conditioner according to the present invention further comprises: a display unit for presenting the recommended setting operation to the occupant; and a decision input unit for entering a decision as to whether to approve or not approve the recommended setting operation, wherein when an approval operation for approving the recommended setting operation is performed via the decision input unit, the air-conditioning control unit controls the air-conditioning unit in accordance with the recommended setting operation.

Preferably, the comfort condition is given as a comfortable temperature probability distribution relating to a passenger compartment temperature that the occupant feels comfortable, the air conditioning state estimating unit obtains the estimated air conditioning state as an estimated temperature probability distribution relating to the passenger compartment temperature that would be achieved after the predetermined time, and the recommended operation determining unit obtains a separation between the comfortable temperature probability distribution and the estimated temperature probability distribution, and determines that the estimated air conditioning state satisfies the comfort condition if the separation is not larger than a predetermined threshold value. In this way, by expressing the air conditioning state in the form of a probability distribution, the automotive air conditioner according to the present invention can accurately determine whether the estimated air conditioning state satisfies the comfort condition.

Preferably, the recommended operation determining unit determines the comfortable temperature probability distribution by using a probabilistic model that takes the state information as an input and that outputs the probability distribution relating to the passenger compartment temperature that the occupant feels comfortable.

Preferably, in this case, the automotive air conditioner according to the present invention further includes: a storage unit for storing, as a set of learned data, a plurality of pieces of state information acquired by the information acquiring unit when in a stable state; and a comfort condition determining unit for generating or updating the probabilistic model by using the set of learned data.

Since the automotive air conditioner according to the present invention learns the condition that the occupant feels comfortable by using the state information acquired in a stable state, the comfort condition can be optimized so as to match the occupant's preference.

Preferably, the state information is an estimated time required to reach a destination, and the fuel economy improving setting operation is an operation for stopping the air-conditioning unit or for bringing the set temperature closer to the temperature outside the vehicle.

Preferably, the air conditioning state estimating unit obtains as the estimated air conditioning state the passenger compartment temperature that would be achieved after the estimated required time, and the recommended operation determining unit determines that the estimated air conditioning state satisfies the comfort condition if the passenger compartment temperature that would be achieved after the estimated required time falls within a prescribed temperature range.

Since the passenger compartment can thus be maintained in a comfortable condition until the vehicle reaches the destination, the automotive air conditioner according to the present invention can improve fuel economy without compromising occupant comfort.

Preferably, the state information is a passenger compartment temperature, and the fuel economy improving setting operation is an operation for stopping the air-conditioning unit or for bringing the set temperature closer to the temperature outside the vehicle.

Preferably, the air conditioning state estimating unit obtains as the estimated air conditioning state the passenger compartment temperature that would be achieved after the predetermined time, and the recommended operation determining unit determines that the estimated air conditioning state satisfies the comfort condition if the passenger compartment temperature that would be achieved after the predetermined time falls within a prescribed temperature range.

Since the passenger compartment can thus be prevented from being excessively cooled or heated, the automotive air conditioner according to the present invention can improve fuel economy without compromising occupant comfort.

Preferably, the recommended operation determining unit obtains a probability concerning the passenger compartment temperature that the occupant feels comfortable by using a probabilistic model that takes the state information as an input, and determines the prescribed temperature range by taking a temperature range where the probability becomes the highest.

In this way, the automotive air conditioner according to the present invention can accurately determine the temperature range where the occupant of the passenger compartment feels comfortable.

According to another aspect of the present invention, there is provided a method for controlling an automotive air conditioner having an air-conditioning unit for supplying conditioned air into a passenger compartment of a vehicle. The control method comprises; acquiring state information indicating a state relating to the vehicle; estimating an air conditioning state inside the passenger compartment that would be achieved after a predetermined time if a setting operation for improving fuel economy were performed based on the state information; recommending the fuel economy improving setting operation if it is determined that the estimated air conditioning state satisfies a comfort condition that would make the passenger compartment comfortable for an occupant; and controlling the air-conditioning unit in accordance with the recommended setting operation.

According to still another aspect of the present invention, there is provided an automotive air conditioner. The automotive air conditioner comprises: an air-conditioning unit for supplying conditioned air into a passenger compartment of a vehicle; an information acquiring unit for acquiring at least one kind of state information indicating a state inside the passenger compartment; a discomfort degree estimating unit for estimating a discomfort degree by using a probabilistic model that takes the at least one kind of state information as an input and that outputs the discomfort degree representing the degree to which an occupant feels uncomfortable; an operation level determining unit for determining an operation level so as to increase the degree of air conditioning if the discomfort degree exceeds a first reference value; and, an air-conditioning control unit for controlling the air-conditioning unit in accordance with the degree of air conditioning determined by the operation level determining unit.

Since the degree of air conditioning is increased according to the discomfort degree of the occupant, the automotive air conditioner according to the present invention can maintain the passenger compartment in a comfortable condition. In particular, since the discomfort degree is estimated by using the probabilistic model that takes the state information concerning the state inside the passenger compartment as an input, the automotive air conditioner can accurately estimate the discomfort degree of the occupant.

Preferably, the automotive air conditioner according to the present invention further includes: an operation unit for regulating the degree of air conditioning; a storage unit for storing the at least one kind of state information as uncomfortable state data corresponding to a state that the occupant feels uncomfortable each time an operation for increasing the degree of air conditioning is performed via the operation unit; and, a discomfort degree estimation model correcting unit for correcting the probabilistic model in such a manner that the discomfort degree associated with the value of the at least one kind of state information increases as the number of pieces of the uncomfortable state data associated with the value of the state information increases.

Preferably, in this case, the storage unit stores the at least one kind of state information as comfortable state data corresponding to a state that the occupant feels comfortable each time an operation for reducing the degree of air conditioning is performed via the operation unit, and the discomfort degree estimation model correcting unit corrects the probabilistic model in such a manner that the discomfort degree associated with the value of the at least one kind of state information decreases as the number of pieces of the comfortable state data associated with the value of the state information increases.

Preferably, the discomfort degree estimation model correcting unit corrects the probabilistic model in such a manner as to change only the discomfort degree associated with the value of the at least one kind of state information that falls within a predetermined range.

Preferably, the information acquiring unit is a far-infrared sensor, and the at least one kind of state information includes a temperature around the occupant which is estimated by the information acquiring unit.

By using the temperature around the occupant for the estimation of the discomfort degree, the automotive air conditioner according to the present invention can accurately estimate the discomfort degree of the occupant.

Preferably, the operation level determining unit determines the operation level so as to reduce the degree of air conditioning if the discomfort degree decreases to or below a second reference value which is lower than the first reference value.

By reducing the degree of air conditioning when the discomfort degree has dropped to a relatively low level, the automotive air conditioner can prevent the passenger compartment from being excessively cooled or heated, and thus, the automotive air conditioner according to the present invention can improve fuel economy while maintaining the passenger compartment in a comfortable condition

Preferably, the discomfort degree estimating unit estimates the discomfort degree that the occupant would feel after a predetermined time if an operation for reducing the degree of air conditioning were performed based on the at least one kind of state information, and the operation level determining unit determines the operation level so as to reduce the degree of air conditioning if the discomfort degree that the occupant would feel after the predetermined time does not exceed the first reference value.

According to yet another aspect of the present invention, there is provided a method for controlling an automotive air conditioner having an air-conditioning unit for supplying conditioned air into a passenger compartment of a vehicle. The control method comprises: acquiring at least one kind of state information indicating a state inside the passenger compartment; estimating a discomfort degree by using a probabilistic model that takes the at least one kind of state information as an input and that outputs the discomfort degree representing the degree to which an occupant feels uncomfortable; determining an operation level so as to increase the degree of air conditioning if the discomfort degree exceeds a first reference value; and, controlling the air-conditioning unit in accordance with the determined degree of air conditioning.

Preferably, in this case, the control method of the automotive air conditioner according to the present invention further includes determining the operation level so as to reduce the degree of air conditioning if the discomfort degree decreases to or below a second reference value which is lower than the first reference value.

Or preferably, the control method of the automotive air conditioner according to the present invention further includes: estimating the discomfort degree that the occupant would feel after a predetermined time if an operation for reducing the degree of air conditioning were performed based on the at least one kind of state information; and determining the operation level so as to reduce the degree of air conditioning if the discomfort degree that the occupant would feel after the predetermined time does not exceed the first reference value.

### DESCRIPTION OF THE DRAWINGS

These and other features and advantages of the present invention will be better understood by referring to the following detailed description, taken together with the drawings wherein:

FIG. 1 is a diagram showing the general configuration of an automotive air conditioner according to a first embodiment of the present invention;

FIG. 2 is a functional block diagram of a controller in the automotive air conditioner according to the first embodiment of the present invention;

FIG. 3 is a diagram showing one example of a probabilistic model used to estimate an air conditioning state;

FIG. 4 is a diagram showing another example of the probabilistic model used to estimate the air conditioning state;

FIG. 5 is a diagram showing still another example of the probabilistic model used to estimate the air conditioning state;

FIG. 6 is a diagram showing one example of a probabilistic model used to obtain a comfort condition;

FIG. 7 is a diagram showing another example of the probabilistic model used to obtain the comfort condition;

FIG. 8 is a flowchart illustrating the air conditioning control operation of the automotive air conditioner according to the first embodiment of the present invention;

FIG. 9 is a flowchart illustrating the air conditioning control operation of the automotive air conditioner according to the first embodiment of the present invention;

FIG. 10 is a diagram showing the general configuration of an automotive air conditioner according to a second embodiment of the present invention;

FIG. 11 is a functional block diagram of a controller in the automotive air conditioner according to the second embodiment of the present invention;

FIG. 12 is a diagram showing one example of a probabilistic model used to estimate a discomfort degree;

FIG. 13 is one example of a table showing the discomfort degree;

FIG. 14 is a state transition diagram of the automotive air conditioner according to the second embodiment of the present invention; and

FIG. 15 is a diagram showing the correspondence between learned data and a label associated with the learned data.

### DESCRIPTION OF THE PREFERRED EMBODIMENT

An automotive air conditioner according to the present invention will be described below with reference to the drawings. However, it should be noted that the present invention is not limited by the description given herein, but embraces the inventions described in the appended claims and their equivalents.

An automotive air conditioner according to a first embodiment of the present invention will be described below.

The automotive air conditioner according to the first embodiment of the present invention estimates the air conditioning state of the passenger compartment that would be achieved after a predetermined time if a particular setting operation for improving fuel economy were performed based on state information indicating the current state of the vehicle. If the estimated air conditioning state is the state that the vehicle occupant will feel comfortable, the automotive air conditioner executes the setting operation either automatically or after presenting it to the occupant and obtaining his or her approval, and the automotive air conditioner thus improves fuel economy while maintaining the passenger compartment in a comfortable condition.

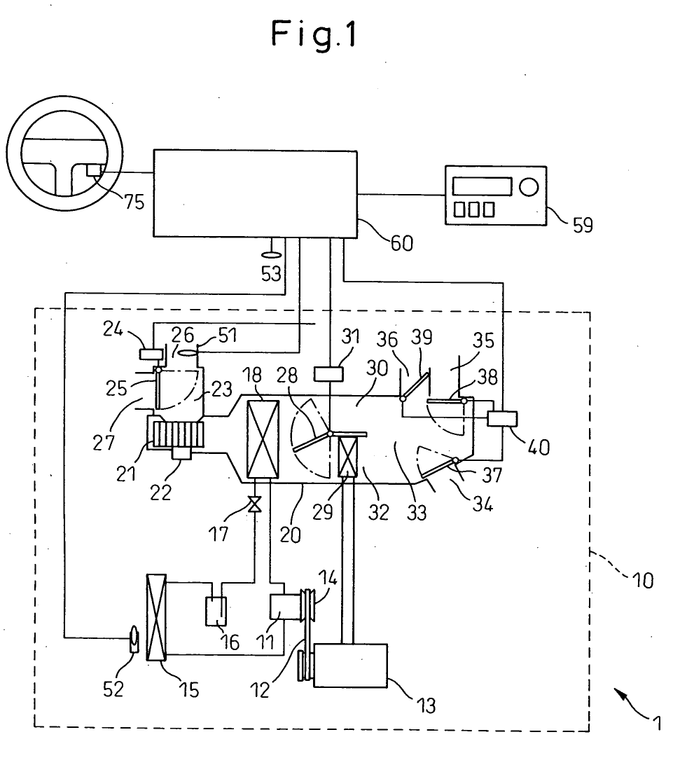

FIG. 1 is a diagram showing the general configuration of the automotive air conditioner 1 according to the first embodiment of the present invention. As shown in FIG. 1, the automotive air conditioner 1 includes an air-conditioning unit 10 comprised mainly of mechanical components, and a controller 60 for controlling the air-conditioning unit 10.

First, the structure of the refrigeration cycle R of the air-conditioning unit 10 will be described. The refrigeration cycle R of the automotive air conditioner 1 is formed from a closed circuit, which comprises a compressor 11, a condenser 15, a receiver 16, an expansion valve 17, and an evaporator 18 arranged in this order in a clockwise direction. The compressor 11 compresses refrigerant and changes it into a high-pressure gas. The compressor 11 is equipped with an electromagnetic clutch 14 for connecting and disconnecting the power being transmitted from an automotive engine 13 via a belt 12. The condenser 15 cools the high-temperature, high-pressure refrigerant gas discharged from the compressor 11 and changes it into a liquid. The receiver 16 stores the liquid refrigerant. To prevent the cooling performance from dropping, the receiver 16 removes gas bubbles contained in the liquid refrigerant, and supplies only the completely liquefied refrigerant to the expansion valve 17. The expansion valve 17 causes the liquid refrigerant to undergo adiabatic expansion and thereby changes it into a low-temperature, low-pressure refrigerant which flows into the evaporator 18. The evaporator 18 performs heat exchange between the low-temperature, low-pressure refrigerant and the air forced to flow over the evaporator 18 which thus cools the air.

Next, the structure inside an air conditioning housing 20 in the air-conditioning unit 10 will be described. A blower fan 21 is located on the upstream side of the evaporator 18. The blower fan is a centrifugal blower fan which is driven by a drive motor 22. An inside/outside air switching box 23 is located on the suction side of the blower fan 21. An inside/outside air switching door 25, which is driven by an inside/outside air servo motor 24, is mounted inside the inside/outside air switching box 23. The inside/outside air switching door 25 is operated between an inside air inlet 26 and an outside air inlet 27. The air drawn through the inside air inlet 26 or the outside air inlet 27 passes through the inside/outside air switching box 23 and is delivered by the blower fan 21 to the evaporator 18. Here, the amount of air to be delivered from the automotive air conditioner 1 can be adjusted by regulating the rotational speed of the blower fan 21.

An air mix door 28 and a heater core 29 are arranged in this order on the downstream side of the evaporator 18. Coolant used to cool the automotive engine 13 is circulated passing through the heater core 29 in order to heat the air passing over the heater core 29. A bypass passage 30 that bypasses the heater core 29 is formed inside the air conditioning housing 20. The air mix door 28 is turned by a temperature control servo motor 31 and adjusts the airflow ratio between the hot air passing through a passage 32 over the heater core 29 and the cold air passing through the bypass passage 30 so that the air controlled to the desired temperature is discharged from the air outlets.

A foot-level outlet 34, a face-level outlet 35, and a defroster outlet 36, through which the conditioned air is blown into the passenger compartment, are provided on the downstream side of an air mixing section 33 where the cold air passed through the bypass passage 30 and the hot air passed through the passage 32 over the heater core 29 are mixed together. A foot-level door 37, a face-level door 38, and a defroster door 39 for opening and closing the respective outlets are provided on the respective outlets. The foot-level outlet 34 is for blowing the conditioned air to the foot level of the driver's seat or the passenger seat, while the face-level outlet 35 is for blowing the conditioned air toward the driver's seat or the passenger seat from the front panel. On the other hand, the defroster outlet 36 is for blowing the conditioned air toward the windshield. The doors 37, 38, and 39 are driven by a mode servo motor 40. Each outlet may be provided with a fin for changing the airflow direction.

Next, a description will be given of various sensors that together function as an information acquiring unit in the automotive air conditioner 1. An inside temperature sensor 51 is mounted together with an aspirator in the instrument panel or the like at a position near the steering wheel in order to measure the temperature (inside temperature) Tᵣ inside the passenger compartment. An outside temperature sensor 52 is mounted in the radiator grille on the front side of the condenser 15 at the front end of the vehicle in order to measure the temperature (outside temperature) Tₐₘ outside the passenger compartment. Further, a solar sensor 53 is mounted inside the passenger compartment at a position near the windshield in order to measure the intensity (amount) of solar radiation S entering the passenger compartment. The solar sensor 53 comprises a photodiode or the like. The inside temperature Tᵣ, the outside temperature Tₐₘ, and the amount of solar radiation S measured by these sensors are used as air conditioning information for the controller 60 to perform temperature control and airflow level control. The details of the temperature control and airflow level control will be described later.

There are also provided such sensors as an evaporator outlet temperature sensor for measuring the temperature of the air (evaporator outlet temperature) leaving the evaporator 18, a heater inlet coolant temperature sensor for measuring the temperature of the engine coolant flowing into the heater core 29, a pressure sensor for measuring the pressure of the refrigerant circulating through the refrigeration cycle R, and an exhaust gas sensor for measuring the odor of exhaust gas. In addition, a humidity sensor, one or more in-car cameras for shooting the faces of the driver and the passenger, an outside camera for viewing outside the vehicle, and a body temperature sensor for acquiring physiological information concerning each occupant, may be mounted inside the passenger compartment.

The automotive air conditioner 1 may be configured to acquire, as state information, not only the sensing information from the above described sensors but also the location information, such as the current location of the vehicle, the heading direction of the vehicle, neighborhood area information, and Gbook information, from a navigation system. It may also be configured to acquire, as state information, various kinds of operation information, such as throttle opening, steering wheel angle, brake pedal position, power window opening, and wiper, turn signal, or car audio ON/OFF state, as well as vehicle speed and vehicle behavior information, from vehicle operation apparatus. Furthermore, the automotive air conditioner 1 may be configured to acquire time information such as the current date and time as state information from a vehicle-mounted clock.

In this way, the navigation system, the vehicle operation apparatus, etc. can also function as an information acquiring unit.

The automotive air conditioner 1 further includes a decision input unit which the occupant uses to approve or reject the recommended air conditioner setting operation. In the present embodiment, a YES/NO switch 75 having a YES button and a NO button is mounted as the approve/reject decision input unit on the steering wheel. The operation to turn on the YES button will be referred to as the approval operation, and the operation to turn on the NO button as the rejection operation. The switch operation performed using the YES/NO switch 75 is relayed to the control unit 60 in the form of an electrical signal.

Alternatively, the decision input unit may be constructed by installing a microphone in the passenger compartment and equipping the control unit 60 with a voice recognition program, with provisions made to determine, in response to the occupant's voice collected by the microphone, whether the recommended operation has been approved (for example, by recognizing a voice “YES”) or rejected (for example, by recognizing a voice “NO”).

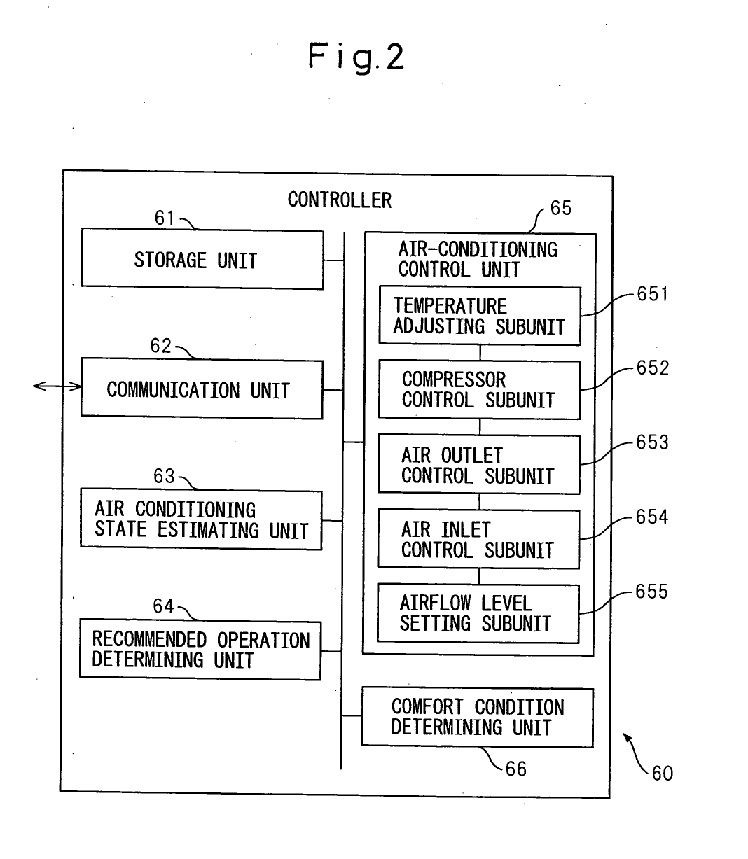

FIG. 2 is a functional block diagram of the controller 60 in the automotive air conditioner 1.

The controller 60 includes: one or more microcomputers not shown, each comprising a CPU, ROM, RAM, etc., and their peripheral circuits not shown; a storage unit 61 constructed from an electrically alterable nonvolatile memory or the like; and a communication unit 62 for performing communications with the various sensors, the navigation system 56, the vehicle operation apparatus 57, etc. in compliance with an automotive communication standard such as Control Area Network (CAN).

The controller 60 further includes an air conditioning state estimating unit 63, a recommended operation determining unit 64, an air-conditioning control unit 65, and a comfort condition determining unit 66, each implemented as a functional module by the microcomputer or by a computer program executed on the microcomputer.

When state information such as the sensing information is acquired, the controller 60 temporarily stores the acquired information in the RAM. Setting information acquired from the A/C operation panel 59 are also stored temporarily in the RAM. The air-conditioning control unit 65 in the controller 60 controls the air-conditioning unit 10 based on the state information and the setting information, and thereby adjusts the ratio of the conditioned air between the various air outlets, the total amount of air, and the temperature of the conditioned air.

The air conditioning state estimating unit 63 estimates the air conditioning state of the passenger compartment that would be achieved after a predetermined time if a certain setting operation leading to improved fuel economy (hereinafter called the fuel economy improving operation) were executed. The recommended operation determining unit 64 determines whether the estimated air conditioning state satisfies the condition that makes the occupant of the passenger compartment feel comfortable (hereinafter called the comfort condition). If the air conditioning state estimated by the air conditioning state estimating unit 63 satisfies the comfort condition, the recommended operation determining unit 64 corrects the air conditioner setting in accordance with the fuel economy improving operation. Alternatively, the recommended operation determining unit 64 presents the fuel economy improving operation to the occupant and, if the occupant approves the recommended fuel economy improving operation thus presented, the recommended operation determining unit 64 corrects the air conditioner setting to match the recommended operation. Then, the air-conditioning control unit 65 controls the air-conditioning unit 10 in accordance with the thus corrected setting. Further, the comfort condition determining unit 66 learns the comfort condition so as to match the occupant's preference. The functional modules for performing the above operations will be described below.

When the state information satisfies a prescribed trigger condition for a particular one of a plurality of preset fuel economy improving operations, the air conditioning state estimating unit 63 estimates the air conditioning state of the passenger compartment that would be achieved after a predetermined time (for example, 10 minutes) if that particular fuel economy improving operation were executed.

The fuel economy improving operations include, for example, the following setting operations. However, the following setting operations are only examples, and other setting operations effective in improving fuel economy may be employed as the fuel economy improving operations.

(1) Fuel economy improving operations to be proposed in summer season and trigger conditions for recommending such operations

(a) When the estimated destination arrival time comes within a predetermined time (for example, 10 minutes) of the current time, an operation is proposed that stops the air-conditioning unit 10 or that raises the set temperature Tₛₑₜ by a predetermined value (for example, 2° C.). Here, stopping the air-conditioning unit 10 means stopping the compressor 11 and the blower fan 21. During the period when the air-conditioning unit 10 is stopped, the control unit 60 may continue to operate in order to monitor the air conditioning state.

(b) When the occupant gets into the vehicle (or the engine is turned on), if the inside temperature Tᵣ, the outside temperature Tₐₘ, and the amount of solar radiation S are not lower than respective predetermined values (for example, Tᵣ≧40° C., Tₐₘ≧30° C., and S≧500 W/m²), an operation is proposed that opens the windows and then closes the windows after a predetermined time (for example, five minutes).

(c) When the measured value from the exhaust gas sensor increases up to or above a predetermined value, an operation is proposed that sets the air inlet mode to the outside air inlet mode and that stops the air-conditioning unit 10 and opens the windows.

(d) When the inside temperature Tᵣ, the outside temperature Tₐₘ and the vehicle speed V are not higher than respective predetermined values, and the amount of solar radiation S is not lower than respective predetermined values (for example, Tᵣ≦28° C., Tₐₘ≦28° C., S≧100 W/m², and V≦80 km/h), an operation is proposed that stops the air-conditioning unit 10 and opens the windows.

(e) If outlet air is not directed toward the occupant, an operation is proposed that directs outlet air toward the occupant.

(f) When the inside temperature Tᵣ drops to or below a predetermined value (for example, 28° C.), an operation is proposed that directs outlet air toward the occupant and lowers the airflow level.

(g) When the inside temperature Tᵣ is not higher than a predetermined value (for example, 25° C.), an operation is proposed that raises the set temperature Tₛₑₜ by a predetermined value (for example, 2° C.).

(h) When the difference between the inside temperature Tᵣ and the outside temperature Tₐₘ is not smaller than a predetermined value (for example, 10° C.), an operation is proposed that raises the set temperature Tₛₑₜ by a predetermined value (for example, 1° C.) at predetermined intervals of time (for example, five minutes) until the difference decreases to or below a threshold value (for example, 5° C.). However, when raising the set temperature, the control unit 60 adjusts the opening of the air mix door 28 so that the air from the evaporator 18 does not pass through the heater core 29.

(2) Fuel economy improving operations to be proposed in winter season and trigger conditions for recommending such operations

(i) When the estimated destination arrival time comes within a predetermined time (for example, 10 minutes) of the current time, an operation is proposed that stops the air-conditioning unit 10 or that lowers the set temperature Tₛₑₜ by a predetermined value (for example, 2° C.).

(j) When the measured value from the exhaust gas sensor increases up to or above a predetermined value, an operation is proposed that sets the air inlet mode to the outside air inlet mode and that stops the air-conditioning unit 10 and opens the windows.

(k) When the humidity inside the passenger compartment is within the range of 40% to 60%, an operation is proposed that stops the compressor 11.

(l) When the inside temperature Tᵣ rises up to or above a predetermined value (for example, 20° C.), an operation is proposed that lowers the airflow level.

(3) Fuel economy improving operations to be proposed in intermediate seasons (spring and autumn) and trigger conditions for recommending such operations
(m) When the estimated destination arrival time comes within a predetermined time (for example, 10 minutes) of the current time, an operation is proposed that stops the air-conditioning unit 10.

(n) When the measured value from the exhaust gas sensor increases up to or above a predetermined value, an operation is proposed that sets the air inlet mode to the outside air inlet mode and that stops the air-conditioning unit 10 and opens the windows.

(o) When the inside temperature Tᵣ, the outside temperature Tₐₘ and the vehicle speed V are not higher than respective predetermined values, and the amount of solar radiation S is not lower than respective predetermined values (for example, Tᵣ≦28° C., Tₐₘ≦28° C., S≧100 W/m², and V≦80 km/h), an operation is proposed that stops the air-conditioning unit 10 and opens the windows.

(p) If outlet air is not directed toward the occupant, an operation is proposed that directs outlet air toward the occupant.

(q) When the inside temperature Tᵣ drops to or below a predetermined value (for example, 26° C.), an operation is proposed that directs outlet air toward the occupant and lowers the airflow level.

(r) When the inside temperature Tᵣ is not higher than a predetermined value (for example, 25° C.), an operation is proposed that raises the set temperature Tₛₑₜ by a predetermined value (for example, 2° C.).

(s) When the difference between the inside temperature Tᵣ and the outside temperature Tₐₘ is not smaller than a predetermined value (for example, 10° C.), an operation is proposed that raises the set temperature Tₛₑₜ by a predetermined value (for example, 1° C.) at predetermined intervals of time (for example, five minutes) until the difference decreases to or below a threshold value (for example, 5° C.). However, when raising the set temperature, the control unit 60 adjusts the opening of the air mix door 28 so that the air from the evaporator 18 does not pass through the heater core 29.

The air conditioning state estimating unit 63 determines the applicable season based on the outside temperature Tₐₘ, and selects from among the above fuel economy improving operations (a) to (s) the fuel economy improving operations for that season as candidates for recommendation. For example, when the outside temperature Tₐₘ is 25° C. or higher, the air conditioning state estimating unit 63 selects the fuel economy improving operations (a) to (h) for the summer season as candidates for recommendation. On the other hand, when the outside temperature Tₐₘ is lower than 15° C., the air conditioning state estimating unit 63 selects the fuel economy improving operations (i) to (l) for the winter season as candidates for recommendation. When the outside temperature Tₐₘ is not lower than 10° C. but not higher than 30° C., the air conditioning state estimating unit 63 selects the fuel economy improving operations (m) to (s) for the intermediate seasons as candidates for recommendation. In a temperature range overlapping between any two seasons, the air conditioning state estimating unit 63 selects the fuel economy improving operations for both of the two seasons as candidates for recommendation. For example, when the outside temperature Tₐₘ is 28° C., the fuel economy improving operations for the summer season and the fuel economy improving operations for the intermediate seasons are selected as candidates for recommendation. The fuel economy improving operations to be selected as candidates for recommendation are thus limited by the air conditioning state estimating unit 63 by referring to the outside temperature Tₐₘ, but instead, the condition relating to the outside temperature Tₐₘ may be included in the trigger condition for each fuel economy improving operation.

When the state information acquired from any sensor satisfies the trigger condition for any one of the above fuel economy improving operations, the air conditioning state estimating unit 63 estimates the air conditioning state of the passenger compartment, for example, the inside temperature Tᵣ, that would be achieved after the predetermined time.

Based on a probabilistic model constructed in advance, the air conditioning state estimating unit 63 obtains the air conditioning state of the passenger compartment the predetermined time later as a probability distribution. In the present embodiment, a Bayesian network is used as the probabilistic model. A Bayesian network is a network that models probabilistic causality relationships among a plurality of events; this network is represented by a directed acyclic graph in which propagation between each node is obtained by a conditional probability. For the details of Bayesian networks, refer to “Bayesian Network Technology” by Yoichi Motomura and Hirotoshi Iwasaki, 1st Edition, Tokyo Denki University Press, July 2006, “Introduction to Bayesian Networks” by Kazuo Shigemasu et al., 1st Edition, Baifukan, July 2006, or “Pattern Recognition” translated by Morio Onoe, 1st Edition, Shin Gijutsu Communications, July 2001.

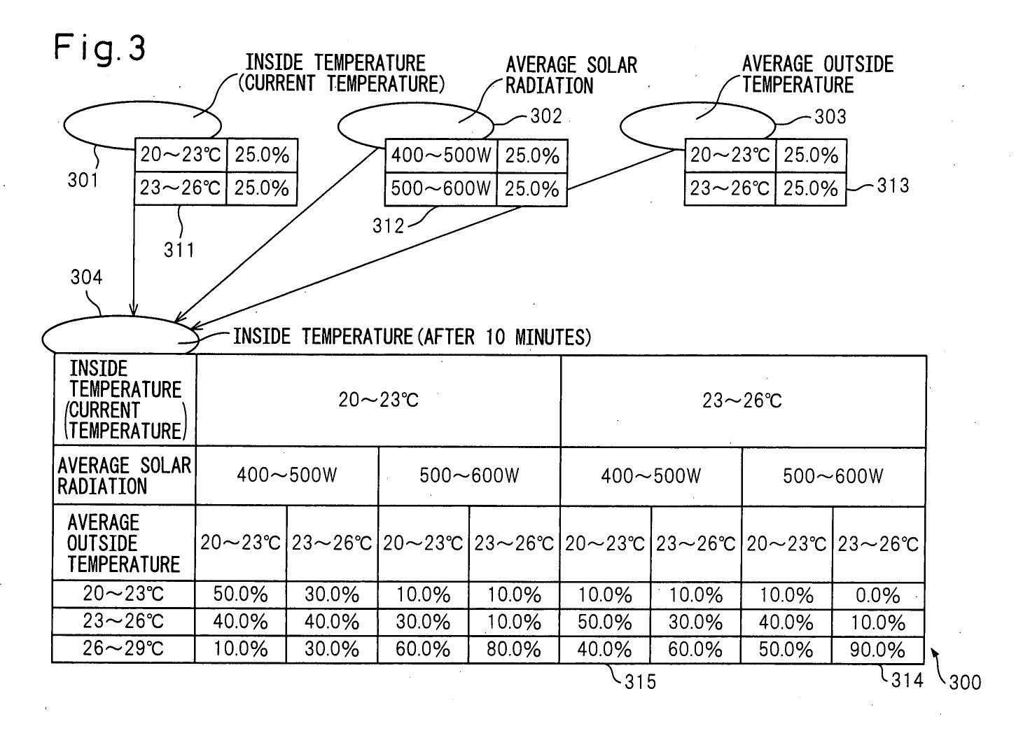

FIG. 3 shows one example of the probabilistic model used to estimate the air conditioning state relating to the fuel economy improving operation (a) or (m) according to the present invention. The probabilistic model 300 shown in FIG. 3 is a Bayesian network of two-layer structure comprising three input nodes 301, 302, and 303 and an output node 304. The input nodes 301 to 303 respectively take as input parameters the inside temperature Tᵣ at the current time, the average amount of solar radiation Sₐᵥ taken over the past 30 minutes, and the average outside temperature Tₐₘₐᵥ taken over the past 30 minutes. Conditional probability tables (CPTs) 311 to 313 are associated with the respective input nodes 301 to 303. Then, by referring to the respective CPTs 311 to 313, the input nodes 301 to 303 each output a prior probability that indicates the probability of the input parameter taking a particular value. For example, when the inside temperature Tᵣ is 25° C., the input node 301 outputs a prior probability indicating that the probability of the inside temperature Tᵣ falling within the range of 23° C. to 26° C. is 1 and the probability of the inside temperature Tᵣ falling within the range of 20° C. to 23° C. or within any other temperature range is 0. If the controller 60 failed to acquire the inside temperature Tᵣ for any reason, the input node 301 refers to the CPT 311 and outputs a probability indicating that the probability of the inside temperature Tᵣ falling within the range of 23° C. to 26° C. or within the range of 20° C. to 23° C. is 0.25, respectively, and the probability of the inside temperature Tᵣ falling within any other temperature range is 0.5.

By referring to the CPT 314 in conjunction with the prior probabilities output from the respective input nodes 301 to 303, the output nodes 304 outputs the estimated probability of the inside temperature Tᵣ to be achieved 10 minutes after the execution of the fuel economy improving operation (a) or (m) (stopping the air-conditioning unit 10). For example, when the inside temperature Tᵣ is 25° C., the average amount of solar radiation Sₐᵥ is 450 W/m₂, and the average outside temperature Tₐₘₐᵥ is 22° C., then it is seen from the column 315 in the CPT 315 that the probabilities of the inside temperature Tᵣ after 10 minutes falling within the range of 20° C. to 23° C., the range of 23° C. to 26° C., and the range of 26° C. to 29° C. are 0.1, 0.5, and 0.4, respectively.

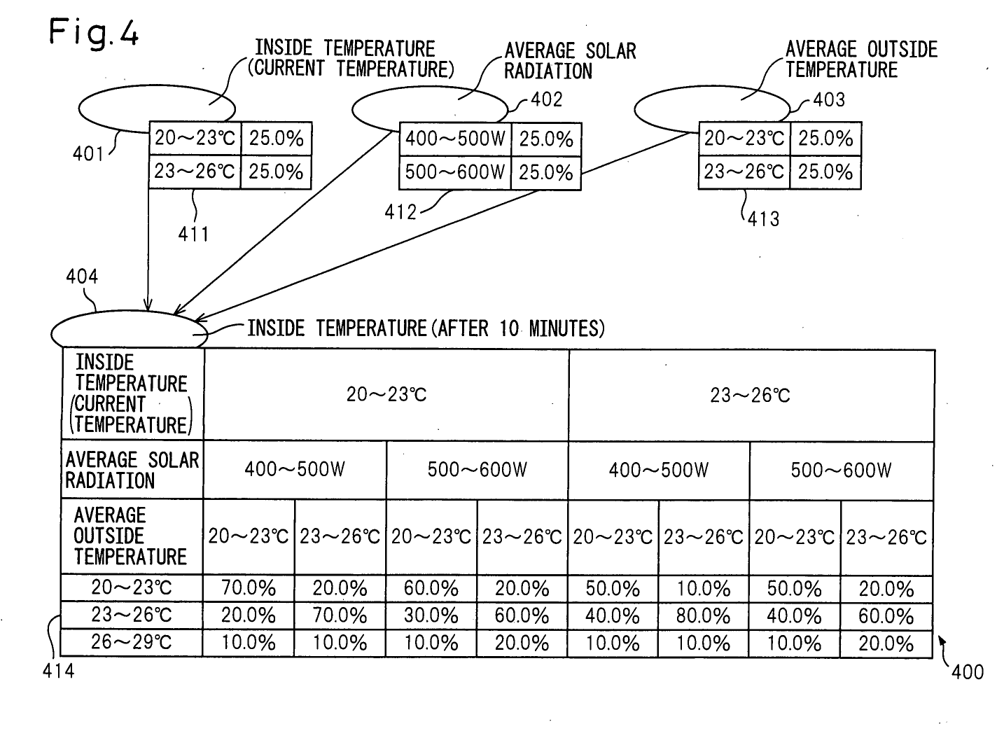

FIG. 4 shows another example of the probabilistic model used to estimate the air conditioning state. The probabilistic model 400 shown in FIG. 4 is used to estimate the inside temperature Tᵣ to be achieved 10 minutes after the execution of the fuel economy improving operation (d) or (o) according to the present embodiment. In FIG. 4, as in the probabilistic model 300, the input nodes 401 to 403 respectively take as input parameters the inside temperature Tᵣ at the current time, the average amount of solar radiation Sₐᵥ, and the average outside temperature Tₐₘₐᵥ, and by referring to the respective CPTs 411 to 413, the input nodes 401 to 403 each output the prior probability of the input parameter taking a particular value. Then, by referring to the CPT 414 in conjunction with the prior probabilities from the respective input nodes, the output node 404 outputs the probability distribution of the inside temperature Tᵣ to be achieved 10 minutes after the execution of the fuel economy improving operation. The probabilistic model 400 may further include an input node that takes an window opening as an input parameter and that outputs the prior probability of the opening. In this case, the output node 404 outputs the probability distribution of the inside temperature Tᵣ to be achieved 10 minutes later, by also referring to the window opening, as a matter of course.

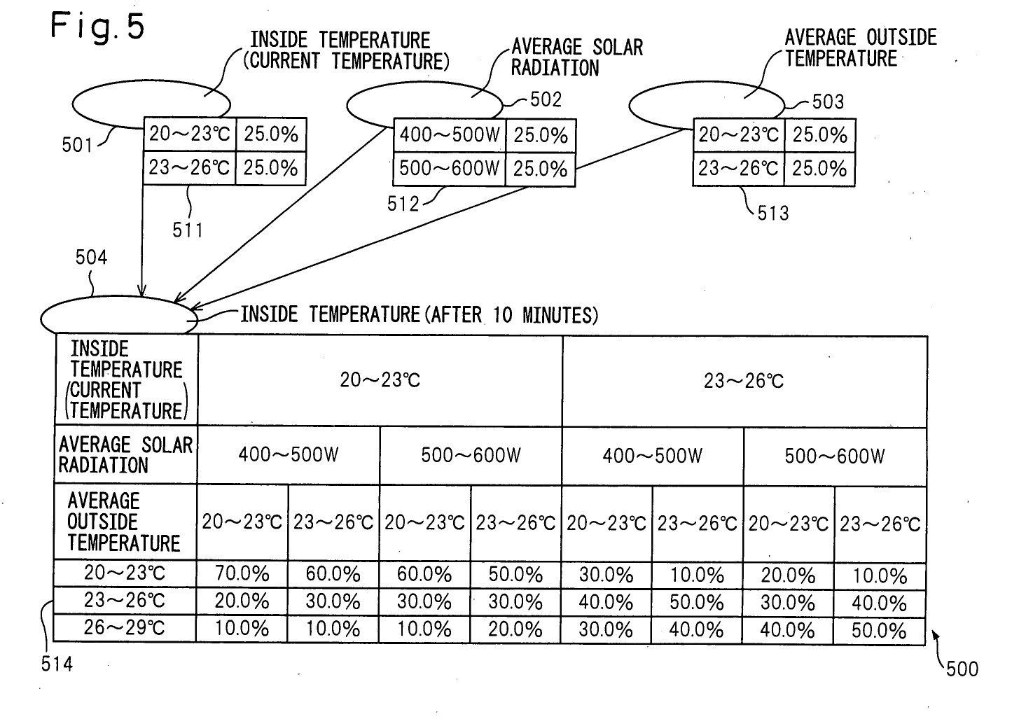

FIG. 5 shows still another example of the probabilistic model used to estimate the air conditioning state. The probabilistic model 500 shown in FIG. 5 is used to estimate the inside temperature Tᵣ to be achieved 10 minutes after the execution of the fuel economy improving operation (g) or (r) according to the present embodiment. In FIG. 5, as in the probabilistic model 300, the input nodes 501 to 503 respectively take as input parameters the inside temperature Tᵣ, the average amount of solar radiation Sₐᵥ, and the average outside temperature Tₐₘₐᵥ, and by referring to the respective CPTs 511 to 513, the input nodes 501 to 503 each output the prior probability of the input parameter taking a particular value. Then, by referring to the CPT 514 in conjunction with the prior probabilities from the respective input nodes, the output node 504 outputs the probability distribution of the inside temperature Tᵣ to be achieved 10 minutes after the execution of the fuel economy improving operation. The probabilistic model 500 may further include an input node that takes the set temperature Tₛₑₜ as an input parameter and that outputs the prior probability of the set temperature Tₛₑₜ. In this case, the output node 504 outputs the probability distribution of the inside temperature Tᵣ to be achieved 10 minutes later, by also referring to the set temperature Tₛₑₜ, as a matter of course.

The air conditioning state to be estimated is not limited to the inside temperature, but the airflow level, the airflow ratio, or a combination thereof may be estimated. For example, the air conditioning state estimating unit 63 may estimate the airflow ratio between the air outlets in connection with the air outlet direction adjusting fuel economy improving operation (e). For example, the air conditioning state estimating unit 63 estimates the airflow ratio such that the airflow from the face-level outlet 35 is 100% and the airflow from the defroster outlet 36 and the foot-level outlet 34 is 0%. In this way, the air conditioning state estimating unit 63 may estimate the air conditioning state based on a deterministic discriminating condition without using a probabilistic model.

The predetermined time based on which to estimate the air conditioning state may be made different for each fuel economy improving operation. For example, in the case of the fuel economy improving operation shown in (a) or (m) above, the predetermined time based on which to estimate the air conditioning state may be the estimated time required to reach the destination. In this case, however, it is preferable to construct a different probabilistic model for each required time or to include in the probabilistic model an input node that takes the estimated required time as an input parameter.

The probabilistic model or the deterministic discriminating condition such as described above is generated in advance empirically or experimentally, and incorporated into the computer program to be executed on the controller 60. Alternatively, the generated data is stored in the storage unit 61.

The recommended operation determining unit 64 determines whether the estimated air conditioning state to be achieved the predetermined time after the execution of the selected fuel economy improving operation satisfies the comfort condition that makes the occupant of the passenger compartment feel comfortable. If it is determined that the comfort condition is satisfied, the recommended operation determining unit 64 recommends the selected fuel economy improving operation.

In the present embodiment, the comfort condition is also given as a probability distribution relating to the air conditioning state of the passenger compartment. Therefore, the recommended operation determining unit 64 obtains the probability distribution representing the comfortable air conditioning state by using the probabilistic model that takes the state information as an input.

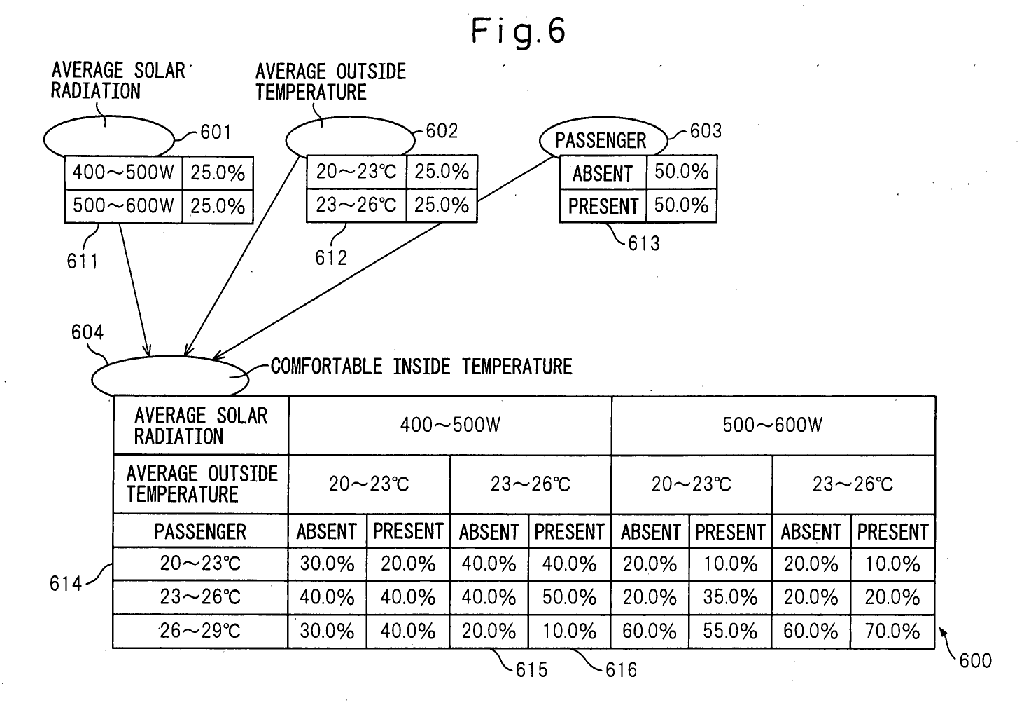

FIG. 6 shows one example of the probabilistic model used to obtain the comfort condition. The probabilistic model 600 shown in FIG. 6 is used for the operation that primarily varies the inside temperature Tᵣ as in the fuel economy improving operation (a) or (m). The probabilistic model 600 is a Bayesian network of two-layer structure comprising three input nodes 601, 602, and 603 and an output node 604. The input nodes 601 to 603 respectively take as input parameters the average amount of solar radiation Sₐᵥ taken over the past 30 minutes, the average outside temperature Tₐₘₐᵥ taken over the past 30 minutes, and the presence/absence of a passenger. CPTs 611 to 613 are associated with the respective input nodes 601 to 603. Then, by referring to the respective CPTs 611 to 613, the input nodes 601 to 603 each output a prior probability that indicates the probability of the input parameter taking a particular value.

By referring to the CPT 614 in conjunction with the prior probabilities received from the respective input nodes 601 to 603, the output node 604 outputs the estimated probability distribution of the inside temperature Tᵣ that the occupant feels comfortable. For example, when the average amount of solar radiation Sₐᵥ is 450 W/m², the average outside temperature Tₐₘₐᵥ is 25° C., and the presence/absence of a passenger is unknown, then it is seen from the columns 615 and 616 in the CPT 614 that the estimated probability that the inside temperature Tᵣ that the occupant feels comfortable lies within the range of 20° C. to 23° C. is (0.4*0.5+0.4*0.5)=0.4. Likewise, the estimated probability that the inside temperature Tᵣ that the occupant feels comfortable lies within the range of 23° C. to 26° C. is (0.4*0.5+0.5*0.5)=0.45. Further, the estimated probability that the inside temperature Tᵣ that the occupant feels comfortable lies within the range of 26° C. to 29° C. is (0.2*0.5+0.1*0.5)=0.15.

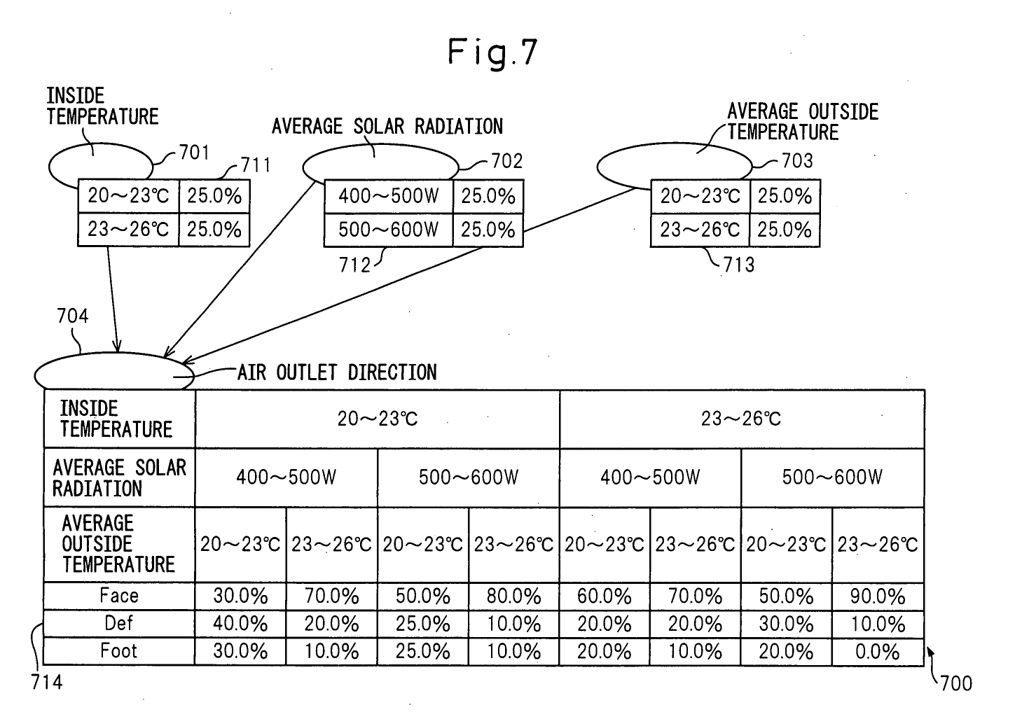

FIG. 7 shows another example of the probabilistic model used to obtain the comfort condition. The probabilistic model 700 shown in FIG. 7 is used for the operation that adjusts the air outlet direction as in the fuel economy improving operation (e). In FIG. 7, the input nodes 701 to 703 respectively take as input parameters the inside temperature Tᵣ, the average amount of solar radiation Sₐᵥ, and the average outside temperature Tₐₘₐᵥ, and by referring to the respective CPTs 711 to 713, the input nodes 701 to 703 each output the prior probability of the input parameter taking a particular value. Then, by referring to the CPT 714 in conjunction with the prior probabilities from the respective input nodes, the output node 704 outputs the probability distribution of the air outlet direction that the occupant feels comfortable.

The condition that makes the occupant of the passenger compartment feel comfortable differs from one occupant to another. Therefore, the probability distribution used to obtain the probability distribution representing the comfort condition is optimized by the comfort condition determining unit 66 by learning. The processing performed by the comfort condition determining unit 66 will be described later.

When the probability distribution representing the comfort condition is obtained, the recommended operation determining unit 64 calculates the KL (Kullback-Leibler) divergence with respect to the probability distribution representing the estimated air conditioning state calculated by the air conditioning state estimating unit 63. The KL divergence is calculated by the following equation.

$$K = \int p ( x ) log \frac{p ( x )}{q ( x )} d x \qquad ( 1 )$$

Here, p(x) is the probability distribution representing the estimated air conditioning state, and q(x) is the probability distribution representing the comfort condition. Further, K is the KL divergence, which defines the separation between the two probability distributions, and K is 0 when p(x) and q(x) perfectly match.

When the KL divergence is smaller than a predetermined threshold value T, the recommended operation determining unit 64 determines that the estimated air conditioning state is comfortable for the occupant, and takes the corresponding fuel economy improving operation as the recommended setting operation. The threshold value T is determined experimentally or empirically.

The recommended operation determining unit 64 checks the value of the automatic execution flag associated with the recommended fuel economy improving operation, and determines whether or not to automatically execute the fuel economy improving operation. The automatic execution flag comprises, for example, one-bit data, and when its value is “1”, the automatic execution flag indicates that the corresponding fuel economy improving operation should be automatically executed. On the other hand, when the value is “0”, the automatic execution flag indicates that the corresponding fuel economy improving operation should be executed after obtaining the occupant's approval.

When the recommended fuel economy improving operation is not to be executed automatically, the recommended operation determining unit 64 determines whether or not to present the recommended fuel economy improving operation to the occupant, based on the number of times, nₚ, that the fuel economy improving operation has been presented in the past and the number of times, nₐ, that the occupant has approved the presented operation. For example, when the number of times of presentation, nₚ, and the number of times of approval, nₐ, for the recommended fuel economy improving operation satisfy the relation nₐ≧nₚ/2, the recommended operation determining unit 64 determines that the recommended operation matches the occupant's preference, and presents the recommended operation to the occupant. When there is no sufficient data based on which to determine whether the recommended fuel economy improving operation matches the occupant's preference (for example, when nₚ<10), the recommended operation determining unit 64 likewise presents the recommended operation to the occupant. On the other hand, when the number of times of presentation, nₚ, and the number of times of approval, nₐ, for the recommended fuel economy improving operation do not satisfy any of the above conditions, the recommended operation determining unit 64 determines that the recommended operation does not match the occupant's preference, and therefore does not present the recommended operation to the occupant.

The number of times of presentation, the number of times of approval, and the updating of the automatic execution flag will be described later in conjunction with the operation procedures of the automotive air conditioner 1.

When presenting the fuel economy improving operation to the occupant (that is, when the value of the automatic execution flag indicates that the operation needs the occupant's approval), the recommended operation determining unit 64 displays the kind of the setting operation on the A/C operation panel 59 or on the display unit of the navigation system or the like to notify the occupant. The recommended operation determining unit 64 may further notify the occupant by annunciating the setting operation by voice through a speaker installed in the passenger compartment. The recommended operation determining unit 64 thus checks with the occupant whether to execute the setting operation.

When the occupant has approved the execution of the fuel economy improving operation by operating the YES/NO switch 75, the recommended operation determining unit 64 corrects the associated setting information. For example, when the fuel economy improving operation (a) is presented, and the occupant approves the presented operation, the recommended operation determining unit 64 corrects the setting information so as to stop the air-conditioning unit 10. On the other hand, when the fuel economy improving operation (g) is presented, and the occupant approves the presented operation, the recommended operation determining unit 64 raises the set temperature Tₛₑₜ by 2° C.

However, when the occupant has rejected the recommended fuel economy improving operation or ignored the presented operation (for example, neither the approval operation nor the rejection operation has been performed within a predefined time after the presentation of the fuel economy improving operation), the recommended operation determining unit 64 does not correct the setting information.

The air-conditioning control unit 65 reads from the RAM the setting information and the sensing information acquired from each sensor, and controls the air-conditioning unit 10 based on the readout values. For this purpose, the air-conditioning control unit 65 includes a temperature adjusting subunit 651, a compressor control subunit 652, an air outlet control subunit 653, an air inlet control subunit 654, and an airflow level setting subunit 655.

The temperature adjusting subunit 651, based on the set temperature Tₛₑₜ and the measurement signals from the temperature sensors and the solar sensor 53, determines the outlet temperature (air conditioning temperature Tₐₒ) of the conditioned air to be discharged from the air outlets. Then, the opening of the air mix door 28 is determined so that the temperature of the conditioned air will become substantially identical with the air conditioning temperature Tₐₒ, and a control signal is sent to the temperature control servo motor 31 which, in response, turns the air mix door 28 to the thus determined position. The opening of the air mix door 28 is determined, for example, based on a control equation that takes as an input a value obtained by correcting the difference between the inside temperature Tᵣ and the set temperature Tₛₑₜ by the outside temperature Tₐₘ, solar radiation S, etc., and that yields the opening of the air mix door 28 as an output. The opening of the air mix door 28 is checked at predetermined intervals of time (for example, every five seconds). The temperature control equation for obtaining the air conditioning temperature Tₐₒ from the measurement values for performing the above control and the mathematical relation that defines the opening of the air mix door 28 are shown below.

Tₐₒ=kₛₑₜTₛₑₜ−kᵣTᵣ−kₐₜₘ−kₛS+C

Do=aTₐₒ+b (2)

In the above equation, Do indicates the opening of the air mix door 28. Further, the coefficients kₛₑₜ, kᵣ, kₐₘ, kₛ, C, a, and b are constants, and Tₛₑₜ, Tᵣ, Tₐₘ, and S denote the set temperature, the inside temperature, the outside temperature, and the amount of solar radiation, respectively. The opening Do of the air mix door 28 is 0% when the passage 32 passing through the heater core 29 is closed (that is, when providing only cooled air) and 100% when the bypass passage 30 is closed (that is, when providing only heated air). The coefficients kₛₑₜ, kᵣ, kₐₘ, kₛ, and C in the temperature control equation and the coefficients a and b in the mathematical relation for finding the opening of the air mix door are set as temperature control parameters.

The temperature adjusting subunit 651 may be configured to determine the air conditioning temperature Tₐₒ and the opening of the air mix door 28 by using other known control methods such as a fussy control method or a control method that uses a neural network. The calculated air conditioning temperature Tₐₒ is stored in the storage unit 60 so that it can be referred to by other constituent units of the controller 60.

The compressor control subunit 652 controls the ON/OFF operation of the compressor 11 based on the air conditioning temperature (outlet air temperature) Tₐₒ obtained by the temperature adjusting subunit 651 as well as on the set temperature Tₛₑₜ, evaporator outlet temperature, etc. When cooling the passenger compartment or operating the defroster, the compressor control subunit 652 usually puts the refrigeration cycle R in operation by operating the compressor 11. However, when the evaporator outlet temperature drops to a level close to the temperature at which the evaporator 18 frosts, the compressor 11 is turned off in order to prevent the evaporator 18 from frosting. Then, when the evaporator outlet temperature increases up to a certain level, the compressor 11 is turned on again. The control of the compressor 11 can be performed using a known method such as a variable capacity control method, and therefore, the details of the control will not be described herein.

The air outlet control subunit 653 determines the airflow ratio of the conditioned air between the various air outlets, based on the airflow ratio value set by the occupant from the A/C operation panel 59, the air conditioning temperature Tₐₒ determined by the temperature adjusting subunit 651, the set temperature Tₛₑₜ, etc. Then, the openings of the foot-level door 37, face-level door 38, and defroster door 39 are determined in accordance with the thus determined airflow ratio. The air outlet control subunit 653 determines the openings of the respective doors 37 to 39 in accordance with a control equation that defines the relationship between the airflow ratio set value, air conditioning temperature Tₐₒ, set temperature Tₛₑₜ, etc. and the openings of the respective doors 37 to 39. Such a control equation is predefined and incorporated into the computer program to be executed on the controller 60. Here, the air outlet control subunit 653 may determine the openings of the respective doors 37 to 39 by using other known methods. The mode servo motor 40 is controlled so that the doors 37 to 39 move to the respectively determined positions.

The air inlet control subunit 654 determines the ratio between the air that the automotive air conditioner 1 draws in through the inside air inlet 26 and the air that it draws in through the outside air inlet 27, based on the air inlet setting acquired from the A/C control panel 59, the set temperature Tₛₑₜ, the air conditioning temperature Tₐₒ, the inside temperature Tᵣ, etc. The air inlet control subunit 654 determines the opening of the inside/outside air switching door 25 in accordance with a control equation that defines the relationship between the inlet air ratio and the outside temperature Tₐₘ, the difference between the inside temperature Tᵣ and the set temperature Tₛₑₜ, etc. Such a control equation is predefined and incorporated into the computer program to be executed on the controller 60. Here, the air inlet control subunit 654 may determine the opening of the inside/outside air switching door 25 by using other known methods. The air inlet control subunit 654 controls the inside/outside air servo motor 24 and turns the inside/outside air switching door 25 so as to achieve the obtained inlet air ratio.

The airflow level setting subunit 655 determines the rotational speed of the blower fan 21, based on the airflow level W acquired from the A/C control panel 59, the set temperature Tₛₑₜ, the air conditioning temperature Tₐₒ, the inside temperature Tᵣ, the outside temperature Tₐₘ, the amount of solar radiation S, etc. Then, a control signal is sent to the drive motor 22 so that the blower fan 21 rotates at the above-set rotational speed. For example, when the airflow level setting is in the manual setting mode, the airflow level setting subunit 655 determines the rotational speed of the blower fan 21 so that it matches the airflow level W acquired from the A/C control panel 59. On the other hand, when the airflow level setting is in the automatic setting mode, the airflow level setting subunit 655 determines the rotational speed of the blower fan 21 in accordance with an airflow level control equation that defines the relationship between the airflow level W and the inside temperature Tᵣ, air conditioning temperature Tₐₒ, etc. Alternatively, an airflow level control equation may be used that directly defines the relationship of the airflow level W relative to the set temperature Tₛₑₜ and the air conditioning information (inside temperature Tᵣ, outside temperature Tₐₘ, and solar radiation S). In this way, various known airflow level control equations can be used. Such a control equation is predefined and incorporated into the computer program to be executed on the controller 60. Alternatively, the airflow level setting subunit 655 may determine the rotational speed of the blower fan 21 by using other known methods such as a map control method which determines the airflow level W corresponding to the measured air conditioning information by referring to a map that defines the relationship between the air conditioning information and the airflow level W.

The air-conditioning control unit 65 may further control door windows and other vehicle-mounted devices via the communication unit 62. For example, when the fuel economy improving operation (b) is executed, the air-conditioning control unit 65 performs control to open the door windows via the communication unit 62.

The comfort condition determining unit 66, based on the state information when the passenger compartment is in a stable air conditioning state, learns the comfort condition that makes the occupant of the passenger compartment feel comfortable, and generates or updates the probabilistic model used to calculate the comfort condition.

First, the learned data used to generate or update the probabilistic model will be explained.

Generally, when the air conditioning state of the passenger compartment is not comfortable for the occupant, the occupant changes the setting of the automotive air conditioner 1. Conversely, when the air conditioning state of the passenger compartment is comfortable for the occupant, it is presumed that the occupant seldom changes the setting of the automotive air conditioner 1.

In view of this, when the occupant has not changed the setting of the automotive air conditioner 1 for a certain period of time, that is, when the passenger compartment is in a stable air conditioning state, the comfort condition determining unit 66 stores the corresponding state information in the storage unit 61 as learned data to be used for the learning of the probabilistic model. This learned data is hereinafter referred to as the learned data CA. For example, when a predetermined time (for example, 30 minutes or one hour) has elapsed since the last time the occupant changed any air conditioner setting, or when the occupant has turned off the vehicle engine, the comfort condition determining unit 66 stores the corresponding state information as the stable state information, i.e., as the learned data CA, in the storage unit 61. Further, after the predetermined time has elapsed since the last time the occupant changed the air conditioner setting, the comfort condition determining unit 66 may acquire the state information at periodic intervals of time, for example, every one hour, until the next time the occupant changes the air conditioner setting, and may accumulate the thus acquired state information as the learned data CA in the storage unit 61. The learned data CA is expressed, for example, as shown by the following equation.

$${C}_{A} = ( \begin{matrix}{c}_{11} & {c}_{12} & {c}_{13} & … & {c}_{11} \\ {c}_{21} & {c}_{22} & & … & {c}_{21} \\ {c}_{31} & & ⋱ & & \\ ⋮ & & & {c}_{ij} & \\ {c}_{m 1} & & & & {c}_{m 1}\end{matrix} ) \qquad ( 3 )$$

where cᵢⱼ represents the value of each piece of state information. Here, i indicates the i-th acquired state information. On the other hand, j is the item number assigned to each value of the state information for convenience; in the present embodiment, the inside temperature Tᵣ is assigned for j=1, the outside temperature Tₐₘ for j=2, and the amount of solar radiation S for j=3. Then, the location information, the vehicle behavior information, the physiological information, etc. are assigned for j=4 and subsequent values of j.

Next, the generation and updating of the probabilistic model will be explained.

When a predetermined time considered long enough to accumulate a sufficient amount of learned data (for example, three months or one year) has elapsed since the accumulation of the learned data CA was started, the comfort condition determining unit 66 generates or updates the probabilistic model by using the learned data CA stored in the storage unit 61.

The generation and updating of the probabilistic model will be explained in detail below by using the probabilistic model 600 shown in FIG. 6.

First, for the input nodes 601 and 602 of the probabilistic model 600, the comfort condition determining unit 66 determines the prior probability for each class of the input parameter values defined in the CPTs 611 and 612, based on the frequency of each class contained in the learned data CA. For example, assume that the learned data CA contains 1000 data sets each comprising simultaneously acquired data such as the outside temperature Tₐₘ, the inside temperature Tᵣ, and the amount of solar radiation S. Here, noting the outside temperature Tₐₘ which is the input parameter to the input node 602, assume that the numbers of data contained in the class not lower than 20° C. but lower than 23° C., the class not lower than 23° C. but lower than 26° C., and other classes are 200, 300, and 500, respectively. In this case, the prior probability of the outside temperature Tₐₘ being not lower than 20° C. but lower than 23° C. is 0.2 which is obtained by dividing the frequency of 200 by the total number, 1000, of data. Likewise, the prior probabilities for the class not lower than 23° C. but lower than 26° C. and other classes are 0.3 and 0.5, respectively. The comfort condition determining unit 66 can obtain the CPT for the remaining input node in the same manner.

For the CPT 614 of the output node 604, the comfort condition determining unit 66 obtains the value of the conditional probability of the inside temperature Tᵣ that the occupant feels comfortable for each combination of the classes of the average outside temperature Tₐₘ, the average amount of solar radiation S, and the presence/absence of a passenger, by dividing the frequency of each value of the inside temperature Tᵣ by the total number of data contained in that combination. For example, assume that in the learned data CA there are 100 data for the combination of the outside temperature Tₐₘ being not lower than 20° C. but lower than 23° C., the amount of solar radiation S being not less than 400 W/m² but less than 500 W/m², and a passenger being present. It is assumed here that, of the 100 data, the number of data acquired when the inside temperature Tᵣ was not lower than 20° C. but lower than 23° C. is 30, the number of data acquired when the inside temperature Tᵣ was not lower than 23° C. but lower than 26° C. is 40, and the number of data acquired when the inside temperature Tᵣ was not lower than 26° C. but lower than 29° C. is 30. In this case, when the outside temperature Tₐₘ is not lower than 20° C. but lower than 23° C., the amount of solar radiation S is not less than 400 W/m² but less than 500 W/m², and a passenger is present, then the conditional probability that the occupant feels comfortable if the inside temperature Tᵣ is not lower than 20° C. but lower than 23° C. is calculated by the comfort condition determining unit 66 as 0.3 by dividing the corresponding number, 30, of data by the total number, 100, of data. Likewise, the conditional probability that the occupant feels comfortable if the inside temperature Tᵣ is not lower than 23° C. but lower than 26° C. and the conditional probability that the occupant feels comfortable if the inside temperature Tᵣ is not lower than 26° C. but lower than 29° C. can be calculated by the comfort condition determining unit 66 as 0.4 (=40/100) and 0.3 (=30/100), respectively.

If it is considered that the number of data used for the learning is not sufficient, the comfort condition determining unit 66 may estimate the probability distribution using a beta distribution. Further, if some of the input information values do not exist in the learned data CA, that is, if there is unobserved data, the comfort condition determining unit 66 estimates the probability distribution of the unobserved data, and calculates the corresponding conditional probability by calculating the expected value based on the estimated distribution. For the learning of such conditional probabilities, use can be made, for example, of the method described in “Introduction to Bayesian Networks” by Kazuo Shigemasu et al., 1st Edition, Baifukan, July 2006, pp. 35-38, 85-87.

The comfort condition determining unit 66 may also determine, by learning, which state information is to be used as the input parameter to the probabilistic model or which graph structure is to be employed for the probabilistic model. An example of such learning will be described below.

First, a plurality of graph structures (hereinafter called the standard models), each having input nodes which take as input parameters the kinds of state information that are likely to have a particularly close relationship to the condition that makes the occupant feel comfortable and an output node which outputs the probability that the occupant feels comfortable, are generated in advance and stored in the storage unit 61.

Then, the comfort condition determining unit 66 generates a tentative probabilistic model for each standard model by determining the conditional probability between each node contained in the standard model. Thereafter, using information criterion, the comfort condition determining unit 66 selects the tentative probabilistic model that has the most appropriate graph structure. The selected model is the probabilistic model used to obtain the comfort condition.

Here, AIC (Akaike's Information Criterion), for example, can be used as the information criterion. AIC can be obtained using the following equation, based on the maximum logarithmic likelihood of the probabilistic model and the number of parameters.

AICm=−21ₘ(θₘ|X)+2kₘ (4)

Here, AICₘ represents the ACI for the probabilistic model M. Further, θₘ represents a set of parameters in the probabilistic model M, while lₘ(θₘ|X) represents the value of the maximum logarithmic likelihood of given data X in the probabilistic model M, and kₘ denotes the number of parameters in the probabilistic model M. Here, lₘ(θₘ|X) can be calculated by the following procedure. First, the comfort condition determining unit 66 obtains the frequency of occurrence from the learned data CA for each combination of parent node variables at each node. Then, the comfort condition determining unit 66 multiplies the frequency of occurrence by the logarithmic value of the conditional probability. Finally, the comfort condition determining unit 66 sums the resulting values to calculate lₘ(θₘ|X). On the other hand, kₘ is obtained by adding together the number of combinations of the parent node variables at each node.

For the selection of the probabilistic model using the information criterion (in other words, the learning of the graph structure), the comfort condition determining unit 66 may use other information criteria such as Bayes's Information Criterion (BIC), Takeuchi's Information Criterion (TIC), or Minimum Description Length (MDL).

The comfort condition determining unit 66 newly generates the probabilistic model in accordance with the above procedure. Or, the comfort condition determining unit 66 updates the existing probabilistic model by rewriting the CPT in accordance with the above procedure. Then, the comfort condition determining unit 66 stores the thus generated or updated probabilistic model in the storage unit 61.

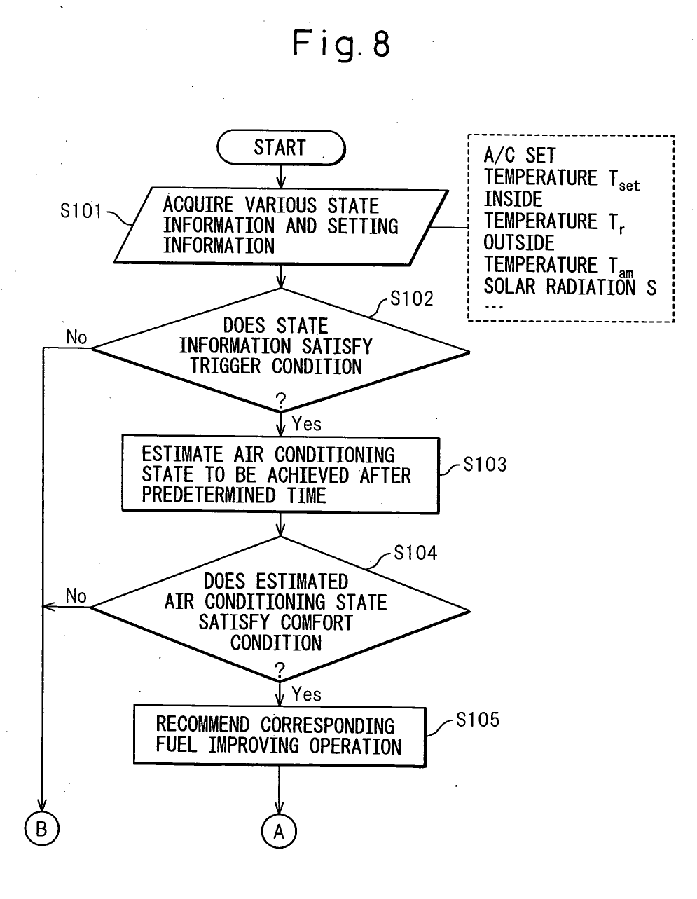

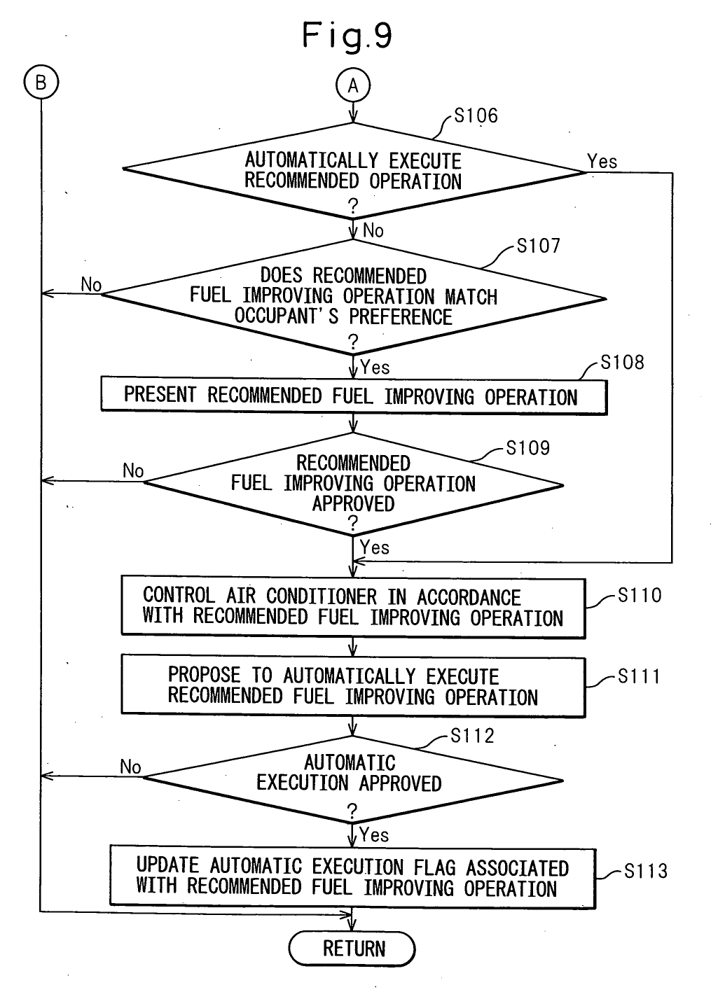

The air conditioning control operation of the automotive air conditioner 1 according to the first embodiment of the present invention will be described below with reference to the flowcharts shown in FIGS. 8 and 9. The air conditioning control operation is performed by the controller 60 in accordance with the computer program incorporated in the controller 60.

First, when power is turned on to the automotive air conditioner 1, the controller 60 acquires from the storage unit 61 the various parameters, etc. that are used to control the automotive air conditioner 1. Further, the controller 60 retrieves the comfort condition stored in the storage unit 61. Then, the controller 60 temporarily stores the parameters and the comfort condition in the RAM of the storage unit 60 so that they can be used during the operation of the automotive air conditioner 1.

As shown in FIG. 8, the controller 60 acquires the setting information, such as the set temperature Tₛₑₜ, the airflow level, etc., and the various kinds of state information from the various sensors, such as the inside temperature Tᵣ, the outside temperature Tₐₘ, the amount of solar radiation S, the estimated time required to reach the destination, and the vehicle speed (step S101). Then, the air conditioning state estimating unit 63 in the controller 60 determines whether the thus acquired state information satisfies the trigger condition for any one of the fuel economy improving operations (step S102). The fuel economy improving operations and their trigger conditions are, for example, shown in (a) to (s) in the earlier description. If the state information does not satisfy the trigger condition for any one of the fuel economy improving operations, the controller 60 terminates the process. On the other hand, if the state information satisfies the trigger condition for any one of the fuel economy improving operations, the air conditioning state estimating unit 63 estimates the air conditioning state of the passenger compartment that would be achieved after a predetermined time if the corresponding fuel economy improving operation were executed (step S103). The air conditioning state estimating unit 63 estimates the air conditioning state (for example, the inside temperature Tᵣ) the predetermined time later, by using the pregenerated probabilistic model or the discriminating condition, as earlier described.

Next, the recommended operation determining unit 64 in the controller 60 determines whether the air conditioning state estimated by the air conditioning state estimating unit 63 satisfies the comfort condition associated with the corresponding fuel economy improving operation (step S104). If the estimated air conditioning state does not satisfy the comfort condition, the controller 60 terminates the process. On the other hand, if the estimated air conditioning state satisfies the comfort condition, the recommended operation determining unit 64 determines the corresponding fuel economy improving operation as the recommended operation (step S105).

As shown in FIG. 9, the recommended operation determining unit 64 checks the automatic execution flag associated with the recommended operation and determines whether the recommended operation is to be automatically executed or not (step S106). If the recommended operation determining unit 64 determines that the recommended operation is to be automatically executed, the controller 60 passes control to step S110 to execute the recommended operation. That is, the recommended operation determining unit 64 corrects the setting information in accordance with the recommended operation, and the air-conditioning control unit 65 in the controller 60 controls the air-conditioning unit 10 by using the corrected setting information.

On the other hand, if it is determined that the recommended operation is not to be automatically executed, the recommended operation determining unit 64 checks the occupant's past response to the recommended operation, and determines whether the recommended operation matches the occupant's preference (step S107). As earlier described, if the number of times of presentation, nₚ, and the number of times of approval, nₐ, for the recommended fuel economy improving operation satisfy the relation nₐ≧nₚ/2, for example, the recommended operation determining unit 64 determines that the recommended operation matches the occupant's preference. The decision is the same when there is not sufficient data based on which to determine whether the recommended fuel economy improving operation matches the occupant's preference (for example, when nₚ<10). On the other hand, if the number of times of presentation, nₚ, and the number of times of approval, nₐ, for the recommended fuel economy improving operation do not satisfy any of the above conditions, the recommended operation determining unit 64 determines that the recommended operation does not match the occupant's preference.

If the recommended operation determining unit 64 determines that the recommended operation does not match the occupant's preference, the controller 60 terminates the process. On the other hand, if the recommended operation determining unit 64 determines that the recommended operation matches the occupant's preference, the recommended operation determining unit 64 notifies the occupant by displaying the kind of the setting operation (step S108). For example, when the recommended operation is the fuel economy improving operation (a), the recommended operation determining unit 64 displays on the A/C operation panel 59, or on the display unit of the navigation system or the like, a message saying, for example, “Soon arriving at the destination. If the air conditioner is turned off, fuel economy can be improved while maintaining the comfortable condition. Do you want to turn off the air conditioner?.” The recommended operation determining unit 64 also delivers the same message by voice through a speaker. Then, the recommended operation determining unit 64 increments the number of times of presentation, nₚ, by 1 for that recommended operation. The recommended operation determining unit 64 then proceeds to determine whether the occupant has approved or rejected the recommended operation (step S109).

If the occupant presses the NO button on the YES/NO switch 75, or operates the A/C operation panel 59 to perform an operation different than the recommended operation, or if no response is received within a predefined time interval (for example, one minute) after the presentation of the recommended operation, the recommended operation determining unit 64 determines that the occupant has rejected the recommended operation, and terminates the process. On the other hand, if the occupant presses the YES button on the YES/NO switch 75 within the predefined time interval, the recommended operation determining unit 64 determines that the occupant has approved the recommended operation. Then, the controller 60 executes the recommended operation (step S110). That is, the recommended operation determining unit 64 corrects the setting information in accordance with the recommended operation, and the air-conditioning control unit 65 controls the air-conditioning unit 10 by using the corrected setting information. Here, the air-conditioning control unit 65 performs control as earlier described. The controller 60 may calculate the estimated value of the fuel economy improving effect achieved by the execution of the recommended operation, and may notify the occupant by displaying the estimated value on the A/C operation panel 59 or on the display unit of the navigation system or the like. Since the estimated value of the fuel economy improving effect can be calculated using a known method, a detailed description will not be given here. Further, the controller 60 may present the result of the fuel economy improvement by analyzing the measured values of the fuel economy improving effect every month or every few months. Alternatively, when the vehicle is parked (at the end of travel), the controller 60 may present the measured value of the fuel economy improving effect achieved by the execution of the recommended operation. By presenting the measured value of the fuel economy improving effect, the automotive air conditioner 1 can enhance the occupant's awareness of the fuel economy improving effect.

After that, the recommended operation determining unit 64 proposes to automatically execute the recommended operation in the future (step S111). For example, when the recommended operation is the fuel economy improving operation (a), the recommended operation determining unit 64 displays on the A/C operation panel 59, or on the display unit of the navigation system or the like, a message saying, for example, “From now on, do you want the air conditioner to be turned off automatically when driving by the same route?.” The recommended operation determining unit 64 also delivers the same message by voice through a speaker. If it is determined that the recommended fuel economy improving operation extremely well matches the occupant's preference, the recommended operation determining unit 64 may display a message saying, for example, “From now on, do you want the air conditioner to be turned off automatically when driving by other routes also?.” For example, for a particular fuel economy improving operation, if the number of times of approval, nₐ, is larger than 80% of the number of times of presentation, nₚ, the recommended operation determining unit 64 determines that the recommended fuel economy improving operation extremely well matches the occupant's preference. The recommended operation determining unit 64 then proceeds to determine whether the occupant has approved or rejected the automatic execution of the fuel economy improving operation (step S112).

If, in step S112, the occupant presses the NO button on the YES/NO switch 75, or nothing is done within a predefined time interval (for example, one minute) after the presentation of the proposal, the controller 60 determines that the occupant has rejected the automatic execution, and terminates the process. On the other hand, if the occupant presses the YES button on the YES/NO switch 75 within the predefined time interval, the recommended operation determining unit 64 determines that the occupant has approved the automatic execution of the fuel economy improving operation. Then, the recommended operation determining unit 64 updates the automatic execution flag associated with that fuel economy improving operation to the value that indicates automatic execution (step S113).

After that, the automotive air conditioner 1 repeats the process of the above steps S101 to S113 at predetermined intervals of time (for example, every 10 seconds) until the power is turned off, that is, until the air conditioner operation is stopped.

As described above, the automotive air conditioner 1 according to the first embodiment of the present invention estimates the air conditioning state of the passenger compartment to be achieved a predetermined time after the execution of a setting operation capable of improving fuel economy, and recommends that setting operation if it is determined that the estimated air conditioning state would be comfortable for the occupant. Then, the automotive air conditioner 1 executes the fuel economy improving setting operation either automatically or when the occupant simply presses the YES button on the YES/NO switch 75 in response to the recommended setting operation. Accordingly, the automotive air conditioner 1 can improve fuel economy while maintaining the passenger compartment in a comfortable condition and without requiring the occupant to go through a complicated procedure.

The present invention is not limited to the above embodiment. For example, the air conditioning state estimating unit 63 may estimate the air conditioning state (for example, the inside temperature Tᵣ) of the passenger compartment the predetermined time later, by using a predictive equation that takes the current state information (for example, the inside temperature Tᵣ, the outside temperature Tₐₘ, the amount of solar radiation S, the vehicle speed V) etc. as inputs. In this case, the recommended operation determining unit 64 may define the comfort condition in terms of a range of values of the estimated air conditioning state. For example, of the temperature ranges defined in the probabilistic model shown in FIG. 6, the temperature range where the probability that the occupant would feel comfortable is the highest may be taken as the range of values. Then, if the estimated air conditioning state falls within the range of values, the recommended operation determining unit 64 determines that it satisfies the comfort condition.

Further, the probabilistic model used for obtaining the comfort condition may be generated based on the state information acquired when the occupant feels that the air conditioning state of the passenger compartment is not comfortable. For example, when the occupant desires to change the set temperature, airflow level, etc. of the automotive air conditioner 1, the air conditioning state of the passenger compartment may not be comfortable for the occupant. Accordingly, the comfort condition determining unit 66 acquires the state information and setting information each time the occupant changes the setting of the automotive air conditioner 1, and stores them as a set of learned data in the storage unit 61. Then, the comfort condition determining unit 66 generates the probabilistic model for obtaining the comfort condition, in the same manner as described earlier. In this case, the generated probabilistic model outputs the probability distribution relating to the air conditioning state that makes the occupant feel uncomfortable. Therefore, the recommended operation determining unit 64 calculates the KL divergence by substituting (1−q(x)) for q(x) in the earlier given equation (1). Alternatively, the recommended operation determining unit 64 may be configured to determine that the estimated air conditioning state satisfies the comfort condition when the KL divergence obtained by the equation (1) is not smaller than a predetermined threshold value.

Further, the recommended operation determining unit 64 may determine the comfort condition without using such a probabilistic model. For example, the range of inside temperatures, the range of airflow levels, the air outlet direction (airflow ratio), etc. that many people feel comfortable may be obtained experimentally, and these parameters may be used to determine the comfort condition.

When executing the recommended fuel economy improving operation, the recommended operation determining unit 64 may store the previous setting in the storage unit 61 and may, after execution, propose via the A/C operation panel 59 or the like to set the air conditioner back to the previous setting (hereinafter called the original setting), if a prescribed condition is satisfied. For example, suppose that the fuel economy improving operation (a) or (i) was proposed and was executed; in this case, when the estimated time required to reach the destination has elapsed, the recommended operation determining unit 64 proposes to set the air conditioner back to the original setting. Furthermore, after executing any one of the fuel economy improving operations, the air conditioning state estimating unit 63 may estimate at periodic intervals of time the air conditioning state to be achieved the predetermined time after the execution of the fuel economy improving operation and, if it is determined that the estimated air conditioning state does not satisfy the comfort condition, the recommended operation determining unit 64 may propose via the A/C operation panel 59 or the like to set the air conditioner back to the original setting. By thus continuing to examine any change that may occur in the air conditioning state to be achieved after the execution of the fuel economy improving operation, the automotive air conditioner 1 can prevent the passenger compartment from being put in an air conditioning state that would make the occupant feel uncomfortable, even when an error has occurred in the estimation of the air conditioning state due to external disturbances after the execution of the fuel economy improving operation.

Further, the probabilistic model for obtaining the comfort condition may be generated for each user registered in the automotive air conditioner 1. Likewise, the number of times of presentation, the number of times of approval, and the automatic execution flag for each fuel economy improving operation may also be stored for each registered user. In this case, an in-car camera for photographing an occupant, for example, is installed, and a matching unit for identifying the occupant based on the image captured by the in-car camera is provided in the controller. When the engine switch is turned on, the matching unit performs the matching and authentication of the occupant based on the image captured by the in-car camera and on the matching information concerning the registered users preregistered in the automotive air conditioner 1, and determines whether the occupant matches any one of the registered users. When a registered user is found that matches the occupant, the controller 60 retrieves from the storage unit 61 the identification information (ID) of the matching registered user and the probabilistic model, etc. associated with that registered user.

Here, the matching unit performs the matching and authentication of the occupant, for example, in accordance with the following method. The matching unit binarizes the image captured by the in-car camera and detects edges in the image to discriminate a region corresponding to the face of the occupant. Then, the matching unit detects features such as eyes, nose, lips, etc., in the thus discriminated face region by such means as edge detection, and extracts a set of feature amounts representing the sizes of the features, their positional relationships relative to each other, etc. Next, the matching unit compares the set of the extracted feature amounts against the sets of feature amounts obtained from the registered users and prestored in the storage unit 61, and computes the degree of matching by using, for example, a correlation computation method. If the highest degree of matching thus obtained is greater than a predetermined threshold value, the matching unit authenticates the occupant as matching the registered user that yielded the highest degree of matching. The above matching method is only one example, and it will be appreciated that the matching unit can perform the matching and authentication of the occupant by using other known matching methods.

Next, an automotive air conditioner according to a second embodiment of the present invention will be described. The automotive air conditioner according to the second embodiment of the present invention automatically starts the air conditioning operation when the occupant of the passenger compartment feels uncomfortable and stops the air conditioning operation when the occupant of the passenger compartment feels comfortable, thereby improving fuel economy while preventing the passenger compartment from being excessively cooled or heated.

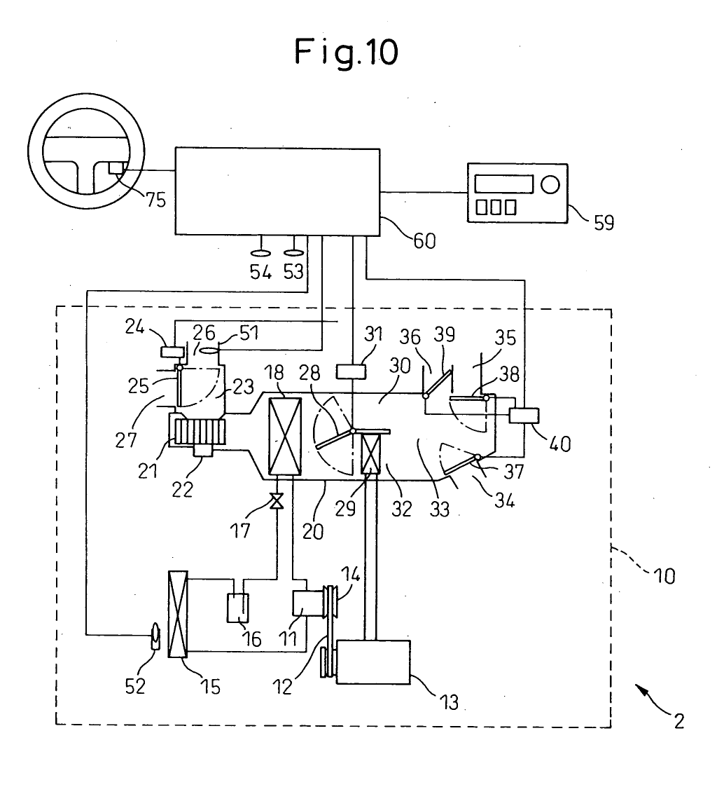

FIG. 10 is a diagram showing the general configuration of the automotive air conditioner 2 according to the second embodiment of the present invention. As shown in FIG. 10, the automotive air conditioner 2 includes a far-infrared sensor 54 in addition to the component elements of the automotive air conditioner 1 of the first embodiment. In FIG. 10, the component elements identical in construction and function to those in automotive air conditioner 1 are designated by the same reference numerals as those designating the corresponding component elements in the automotive air conditioner 1. The automotive air conditioner 2 will be describe below by dealing only with the differences from the automotive air conditioner 1.

The far-infrared sensor 54 detects the far-infrared radiation emanating from the occupant, estimates the temperature around the occupant, and sends the estimated temperature to the controller 60. For this purpose, the far-infrared sensor 54 is installed, for example, on the instrument panel, and is connected to the controller 60. The far-infrared sensor 54 acquires a far-infrared image captured of the vehicle driver. Then, the far-infrared sensor 54 extracts the region corresponding to the driver (especially, the driver's skin surface) from the far-infrared image. The far-infrared sensor 54 estimates the temperature around the driver by taking a statistic (for example, the mean, median, or mode) of the luminance values of the pixels contained in that region. Here, the far-infrared sensor 54 may estimate the temperature around the driver based on the statistic of the luminance values taken at one or more predetermined points within the captured image region. Alternatively, the far-infrared sensor 54 may be installed on the ceiling of the passenger compartment so as to capture an image of the entire compartment. In this case, the far-infrared sensor 54 may extract the region corresponding to the driver and the region corresponding to the passenger, and may estimate the average value of the temperatures around the respective occupants based on the statistics of the luminance values of the pixels contained in these regions.

The far-infrared sensor 54 estimates the temperature around the occupant periodically or at the request of the controller 60 during the operation of the automotive air conditioner 2. Then, the far-infrared sensor 54 sends the estimated temperature to the controller 60.

The YES/NO switch 75 is a switch for switching the air conditioner between the eco-operation mode in which the air conditioning operation is automatically started and stopped and the normal operation mode in which the air conditioner is operated in accordance with the occupant's setting. In the present embodiment, when the YES button on the YES/NO switch 75 is pressed, the automotive air conditioner 2 is set to the eco-operation mode, and when the NO button is pressed, the automotive air conditioner 2 is set to the normal operation mode.

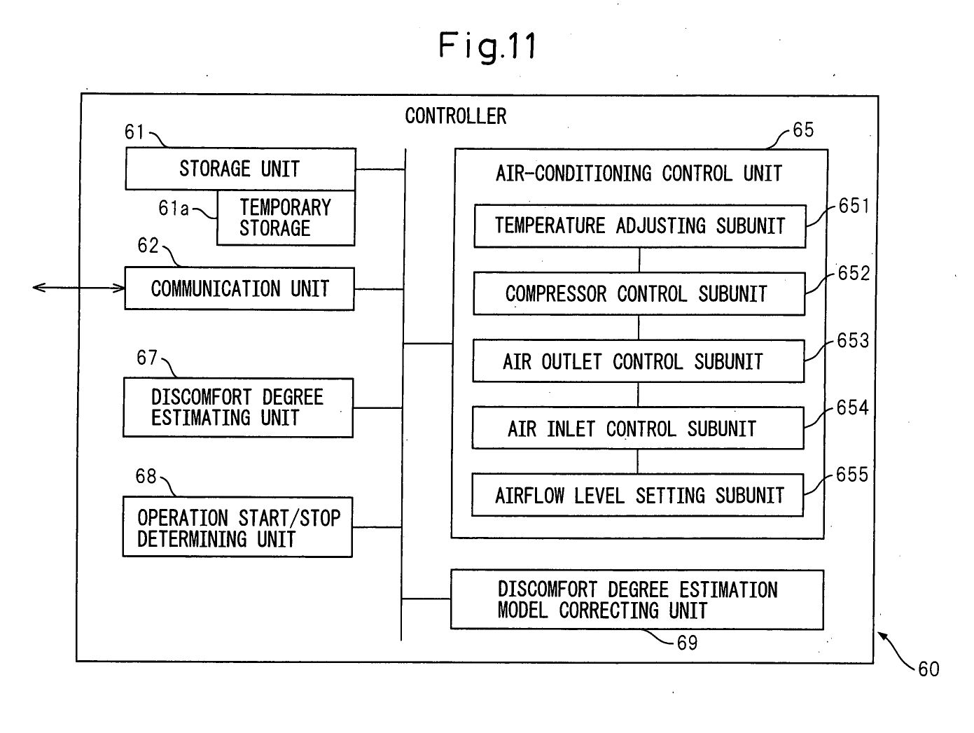

FIG. 11 is a functional block diagram of the controller 60 in the automotive air conditioner 2.

The controller 60 includes: one or more microcomputers not shown, each comprising a CPU, ROM, RAM, etc., and their peripheral circuits not shown; a storage unit 61 constructed from an electrically alterable nonvolatile memory or the like; a temporary storage area 61a formed from a ring buffer; and, a communication unit 62 for performing communications with the various sensors, the navigation system 56, the vehicle operation apparatus 57, etc. in compliance with an automotive communication standard such as Control Area Network (CAN).

The controller 60 further includes an air-conditioning control unit 65, a discomfort degree estimating unit 67, an operation level determining unit 68, and a discomfort degree estimation model correcting unit 69, each implemented as a functional module by the microcomputer or by a computer program executed on the microcomputer. The storage unit 61, the communication unit 62, and the air-conditioning control unit 65 are identical in function and configuration to the corresponding component elements of the automotive air conditioner 1 according to the first embodiment, and therefore, these units will not be described in detail herein.

The discomfort degree estimating unit 67 estimates the degree to which the occupant feels uncomfortable, i.e., the discomfort degree, as a criterion for determining whether the operation of the automotive air conditioner 2 is to be started or stopped. In the present embodiment, the discomfort degree estimating unit 67 calculates the conditional probability PIR_{Feel}=P(IP_{Feel}=Discomfort|IR_{d}, ΔIR_{d}) as the discomfort degree. Here, IP_{Feel} is a state variable that indicates whether the occupant feels comfortable or uncomfortable. IR_{d} is the temperature around the occupant acquired from the far-infrared sensor 54 during the estimation of the discomfort degree. Further, ΔIR_{d} is the absolute difference (i.e., the amount of temperature change) between the temperature around the occupant acquired when the air conditioning operation state of the automotive air conditioner 2 was last changed (including not only when the air conditioning operation state of the automotive air conditioner 2 was changed by the occupant operating the A/C operation panel 59, but also when the air conditioning operation state of the automotive air conditioner 2 was changed by the automotive air conditioner 2 itself) and the temperature around the occupant acquired during the estimation of the discomfort degree. In the present embodiment, a discomfort degree estimation model is used to estimate the discomfort degree PIR_{Feel}. Here, ΔIR_{d} may be the absolute difference between the temperature around the occupant acquired during the estimation of the discomfort degree and the temperature around the occupant acquired a predetermined time (for example, 40 seconds) before that. Alternatively, ΔIR_{d} may be the amount of change of the temperature around the occupant per unit time (for example, per minute or per second).

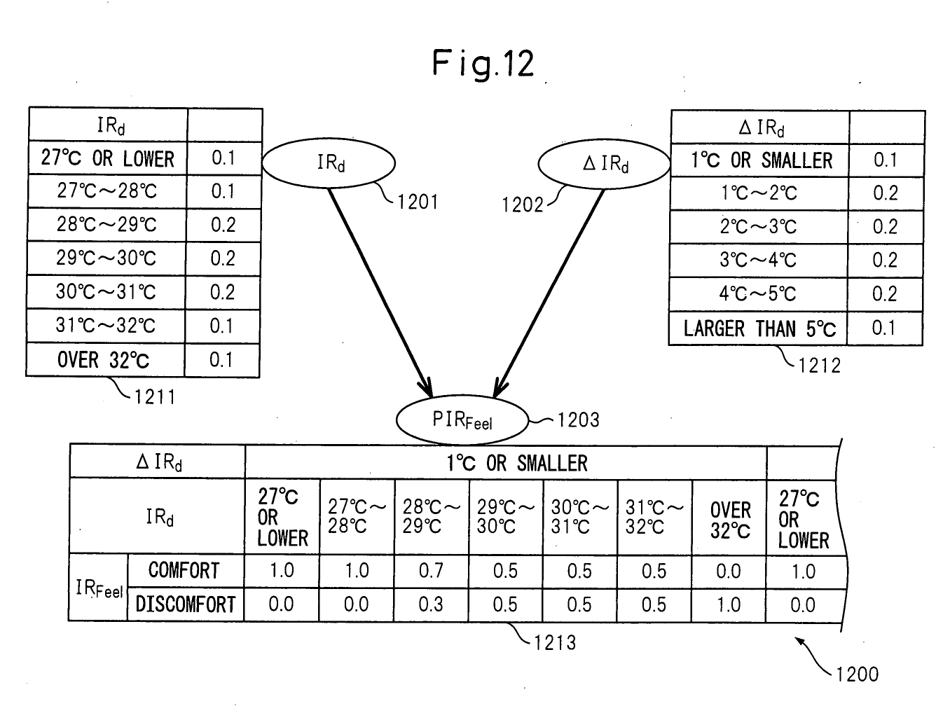

FIG. 12 shows one example of the discomfort degree estimation model used to estimate the discomfort degree PIR_{Feel}. The discomfort degree estimation model 1200 is a Bayesian network of two-layer structure comprising two input nodes 1201 and 1202 and an output node 1203. The input nodes 1201 and 1202 take the temperature IR_{d} and the amount of temperature change ΔIR_{d}, respectively, as input parameters. CPTs 1211 and 1212 are associated with the respective input nodes 1201 and 1202. Then, by referring to the respective CPTs 1211 and 1212, the input nodes 1201 and 1202 each output a prior probability that indicates the probability of the input parameter taking a particular value. Here, when the measured values of the temperature IR_{d} and the amount of temperature change ΔIR_{d} are obtained, the input nodes 1201 and 1202 each output 1 as the prior probability associated with the corresponding measured value and 0 as the prior probabilities associated with other values. For example, when the measured value of the temperature IR_{d} is 29.2° C., the input node 1201 refers to the CPT 1211 and sets the prior probability of the 29° C. to 30° C. class to 1 and the prior probabilities of other classes to 0. Likewise, when the measured value of the amount of temperature change ΔIR_{d} is 1.8° C., the input node 1202 refers to the CPT 1212 and sets the prior probability of the 1° C. to 2° C. class to 1 and the prior probabilities of other classes to 0.

By referring to the CPT 1213 in conjunction with the prior probabilities received from the respective input nodes 1201 and 1202, the output node 1203 calculates the discomfort degree PIR_{Feel} and the comfort degree of the occupant (=P(IF_{Feel}=Comfort|IR_{d}, ΔIR_{d})). Here, the comfort degree of the occupant is given as (1−PIR_{Feel}). For example, assume that, for the temperature IR_{d}, the prior probability of the 29° C. to 30° C. class is 1 and the prior probabilities of other classes are 0, and that, for the amount of temperature change ΔIR_{d}, the prior probability of the 1° C. to 2° C. class is 1 and the prior probabilities of other classes are 0, as described above. In this case, the output node 1203 outputs 0.5 as the discomfort degree PIR_{Feel} by referring to the CPT 1213.

The discomfort degree estimating unit 67 supplies the thus obtained discomfort degree PIR_{Feel} to the operation level determining unit 68.

The discomfort degree estimating unit 67 may determine the discomfort degree PIR_{Feel} based on only either one of the above parameters, the temperature IR_{d} or the amount of temperature change ΔIR_{d}. In this case, the discomfort degree estimation model can be constructed as a Bayesian network of two-layer structure comprising one input node that takes either the temperature IR_{d} or the amount of temperature change ΔIR_{d} as an input parameter and an output node that takes the prior probability of that input parameter as an input and outputs the discomfort degree PIR_{Feel}.

Further, the discomfort degree estimating unit 67 may calculate the discomfort degree based on state information other than the temperature around the occupant. For example, a humidity sensor may be installed in the passenger compartment, and the discomfort degree estimating unit 67 may calculate the discomfort degree based on the humidity in the passenger compartment detected by the humidity sensor. Alternatively, the discomfort degree estimating unit 67 may estimate the discomfort degree based on both the temperature around the occupant and the humidity in the passenger compartment. Further, the discomfort degree estimating unit 67 may calculate the discomfort degree based on the evaporator outlet temperature detected by the evaporator outlet temperature sensor. In this case, the discomfort degree estimating unit 67 may calculate the discomfort degree PIR_{Feel} in such a manner that the discomfort degree PIR_{Feel} becomes very high (for example, the discomfort degree PIR_{Feel} becomes 1) when the evaporator outlet temperature reaches a temperature at which the evaporator emits an odor or a temperature 1 to 3° C. lower than that temperature. Further, the discomfort degree estimating unit 67 may calculate the discomfort degree based on the inside temperature Tᵣ, the amount of solar radiation S, etc. or on these parameters plus the temperature around the occupant and/or the humidity in the passenger compartment. In either case, the discomfort degree estimating unit 67 can calculate the discomfort degree by using as the discomfort degree estimation model a probabilistic model that takes these pieces of state information as input parameters and that outputs the discomfort degree.

Further, the discomfort degree estimating unit 67 may use a plurality of probabilistic models that respectively take these pieces of state information or combinations thereof as input parameters and that output discomfort degrees. In this case, of the discomfort degrees output from the respective probabilistic models, the discomfort degree estimating unit 67 supplies the highest one to the operation level determining unit 68.

When a signal indicating the depression of the YES button is received from the YES/NO switch 75, the operation level determining unit 68 sets the automotive air conditioner 2 to the eco-operation mode. When the automotive air conditioner 2 is in the eco-operation mode, the operation level determining unit 68, based on the discomfort degree supplied from the discomfort degree estimating unit 67, determines whether the automotive air conditioner 2 should be operated for air conditioning or not. When the operation level determining unit 68 determines that the automotive air conditioner 2 should be operated for air conditioning, the air-conditioning control unit 65 controls the air-conditioning unit 10 in accordance with the setting information such as the set temperature, etc. set at that time, and operates the automotive air conditioner 2 to cool or heat the passenger compartment. On the other hand, when the operation level determining unit 68 decides to stop the air conditioning operation of the automotive air conditioner 2, the air-conditioning control unit 65 stops the operation of the air-conditioning unit 10.

When a signal indicating the depression of the NO button is received from the YES/NO switch 75, the operation level determining unit 68 sets the automotive air conditioner 2 to the normal operation mode. When the automotive air conditioner 2 is set to the normal operation mode, the automotive air conditioner 2 operates for air conditioning in accordance with the setting information acquired from the A/C operation panel 59.

The operation of the operation level determining unit 68 in the eco-operation mode will be described below. The following description deals with the case where the automotive air conditioner 2 is operating in a cooling mode. It will, however, be recognized that the operation of the operation level determining unit 68 is essentially the same when the automotive air conditioner 2 is operating in a heating mode.

When the air conditioning operation is off, the operation level determining unit 68 compares the discomfort degree PIR_{Feel} with a predetermined threshold value ThIRp at periodic intervals of time (for example, every 10 seconds). When the discomfort degree PIR_{Feel} exceeds the threshold value ThIRp, the operation level determining unit 68 causes the automotive air conditioner 2 to start the air conditioning operation. That is, the operation level determining unit 68 instructs the air-conditioning control unit 65 to operate the air-conditioning unit 10 in the cooling mode. The threshold value ThIRp can be determined in advance based on such quantities as the statistic (for example, the mean, median, or mode) of the discomfort degree acquired when the occupant performed an operation to start the air conditioning operation.

On the other hand, when the temperature around the occupant acquired from the far-infrared sensor 54 becomes lower by a predetermined number of degrees than the temperature IRCp around the occupant at which the automotive air conditioner 2 started the air conditioning operation, the operation level determining unit 68 causes the automotive air conditioner 2 to stop the air conditioning operation. That is, the operation level determining unit 68 instructs the air-conditioning control unit 65 to stop the cooling operation of the air-conditioning unit 10. The temperature at which the automotive air conditioner 2 stops the air conditioning operation is hereinafter called the air conditioning stopping temperature IRCn. (When the automotive air conditioner 2 is operating in the heating mode, the air conditioning stopping temperature IRCn is set higher by a predetermined number of degrees than the temperature IRCP at which the air conditioning operation was started. Then, when the temperature around the occupant acquired from the far-infrared sensor 54 rises and reaches the air conditioning stopping temperature IRCn, the operation level determining unit 68 causes the automotive air conditioner 2 to stop the air conditioning operation.)

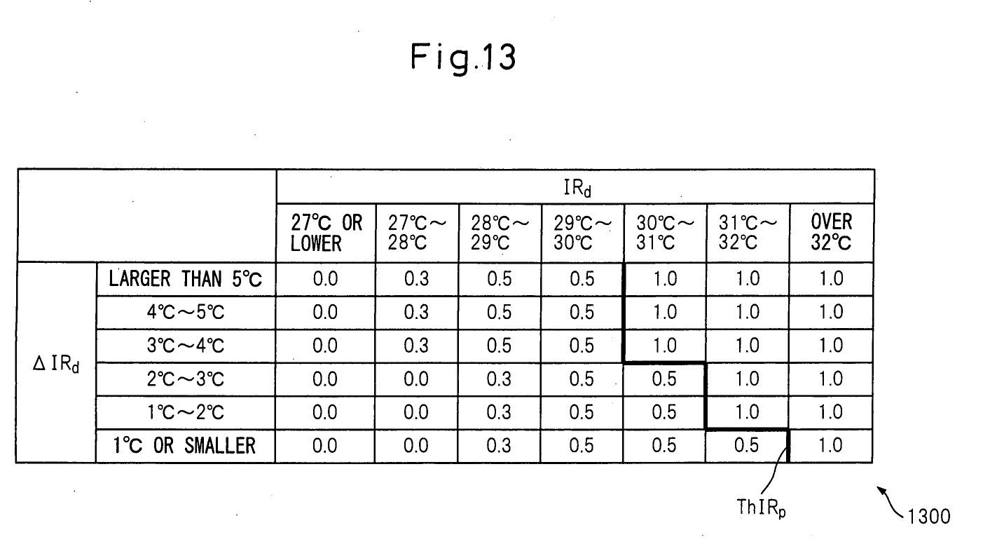

The above control process will be explained with reference to FIG. 13. It is assumed here that the threshold value ThIRp is 0.8. It is also assumed that the air conditioning stopping temperature IRCn is set 1° C. lower than the temperature IRCP at which the air conditioning operation was started. Of the entries shown in the CPT 1213 in FIG. 12, only the discomfort degree PIR_{Feel} is shown in the table 1300 of FIG. 13. The numerical values shown in each column of the table 1300 indicate the discomfort degree PIR_{Feel}.

For example, suppose that the measurements made during the off period of the air conditioning operation showed that the temperature IR_{d} was 30.3° C. and the amount of temperature change ΔIR_{d} was 4.8° C. In this case, from the table 1300, the discomfort degree PIR_{Feel} is 1.0. Since this discomfort degree PIR_{Feel} is higher than the threshold value ThIRp, the operation level determining unit 68 causes the automotive air conditioner 2 to start the air conditioning operation. Here, the air conditioning stopping temperature IRCn is set to 29.3° C. When the temperature IR_{d} thereafter drops to 29.3° C. or lower, the operation level determining unit 68 causes the automotive air conditioner 2 to stop the air conditioning operation.

On the other hand, suppose that the measurements made showed that the temperature IR_{d} was 30.3° C., as in the above case, but the amount of temperature change ΔIR_{d} was 1.2° C. In this case, from the table 1300, the discomfort degree PIR_{Feel} is 0.5 which is lower than the threshold value ThIRp. Accordingly, the operation level determining unit 68 continues to hold the air conditioning operation in the off state. When the measured value of the amount of temperature change ΔIR_{d} is 1.2° C., the operation level determining unit 68 causes the automotive air conditioner 2 to start the air conditioning operation when the temperature IR_{d} exceeds 31° C. Accordingly, if IRCP is 31.5° C., the operation level determining unit 68 sets IRCn to 30.5° C. When the temperature IR_{d} thereafter drops to 30.5° C. or lower, the operation level determining unit 68 causes the automotive air conditioner 2 to stop the air conditioning operation.

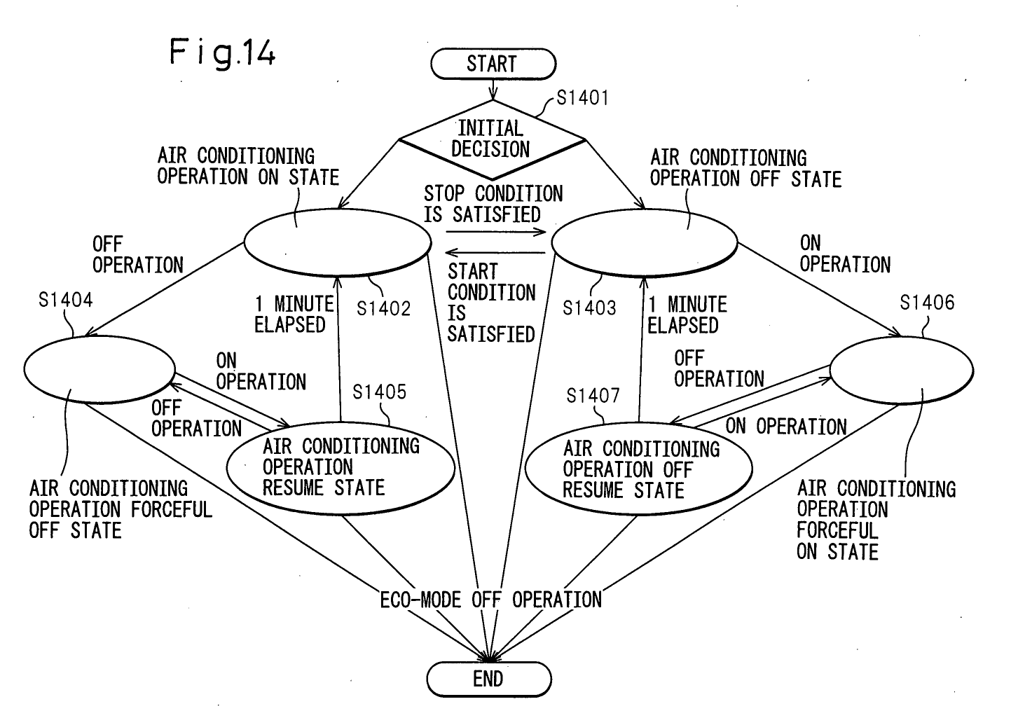

Next, the transition of the air conditioning operation state of the automotive air conditioner 2 will be described with reference to FIG. 14. The state transition is effected by the operation level determining unit 68. In the present embodiment, the air conditioning operation state of the automotive air conditioner 2 does not make a transition even if the occupant performs any operations (such as changing the airflow level, air outlet direction, set temperature, etc.) on the A/C operation panel 59 other than the operation for turning on or off the automotive air conditioner 2.

First, when the automotive air conditioner 2 is set to the eco-operation mode by the YES/NO switch 75, the operation level determining unit 68 determines whether the air conditioning operation should be started or not (step S1401). More specifically, the operation level determining unit 68 calculates the discomfort degree PIR_{Feel} by entering the temperature IR_{d} and the amount of temperature change ΔIR_{d} (=0) at that time into the discomfort degree estimation model. If the discomfort degree PIR_{Feel} is higher than the threshold value ThIRp, the operation level determining unit 68 causes the automotive air conditioner 2 to start the air conditioning operation. The automotive air conditioner 2 is thus put into the air conditioning operation ON state (step S1402). On the other hand, if the discomfort degree PIR_{Feel} is not higher than the threshold value ThIRp in step 1401, the operation level determining unit 68 causes the automotive air conditioner 2 to stop the air conditioning operation, and the automotive air conditioner 2 is thus put into the air conditioning operation OFF state (step S1403).

In the air conditioning operation ON state (step S1402), if the temperature IR_{d} drops to or below the air conditioning stopping temperature IRCn, as earlier described, the operation level determining unit 68 causes the automotive air conditioner 2 to stop the air conditioning operation. The automotive air conditioner 2 thus moves to the air conditioning operation OFF state (step S1403). Here, if the automotive air conditioner 2 is operating so as to prevent the generation of odors from the evaporator, the air conditioning operation ON state may be maintained until the evaporator outlet temperature drops below a relatively low predetermined temperature (for example, 2° C.). In this case, when the evaporator outlet temperature drops below the predetermined temperature, the operation level determining unit 68 causes the automotive air conditioner 2 to stop the air conditioning operation.

In the air conditioning operation OFF state (step S1403), if the discomfort degree PIR_{Feel} exceeds the threshold value ThIRp, the operation level determining unit 68 causes the automotive air conditioner 2 to start the air conditioning operation. The automotive air conditioner 2 thus moves to the air conditioning operation ON state (step S1402). Here, if the automotive air conditioner 2 is operating so as to prevent the generation of odors from the evaporator, the operation level determining unit 68 may also cause the automotive air conditioner 2 to start the air conditioning operation when the evaporator outlet temperature has increased up to (Twet-3)° C. or higher. Here, Twet is the wet-bulb temperature of the evaporator surface (the temperature at which the evaporator surface can be maintained in a wet condition).

In the air conditioning operation ON state (step S1402), if the occupant turns off the automotive air conditioner 2 by operating the A/C operation panel 59, the operation level determining unit 68 causes the automotive air conditioner 2 to stop the air conditioning operation. The automotive air conditioner 2 thus moves to the air conditioning operation forceful OFF state (step S1404).

In the air conditioning operation forceful OFF state (step S1404), if the occupant turns on the automotive air conditioner 2 by operating the A/C operation panel 59, the operation level determining unit 68 causes the automotive air conditioner 2 to start the air conditioning operation. The automotive air conditioner 2 thus moves to the air conditioning operation resume state (step S1405). When a predetermined time (for example, one minute) has elapsed from the start of the air conditioning operation resume state (step S1405), the operation level determining unit 68 automatically causes the automotive air conditioner 2 to move to the air conditioning operation ON state (step S1402). However, if the occupant turns off the automotive air conditioner 2 by operating the A/C operation panel 59 before the predetermined time elapses from the start of the air conditioning operation resume state (step S1405), the operation level determining unit 68 causes the automotive air conditioner 2 to stop the air conditioning operation. The automotive air conditioner 2 thus moves back to the air conditioning operation forceful OFF state (step S1404).

When the automotive air conditioner 2 is in the air conditioning operation resume state, if the temperature IR_{d} drops to IRCn or lower, the air conditioning operation will not be stopped (that is, the automotive air conditioner 2 will not move to the air conditioning operation OFF state). This is because the automotive air conditioner 2 being put in the air conditioning operation resume state means that the air conditioning operation has just been resumed in accordance with the occupant's request, and therefore, automatically stopping the air conditioning operation of the automotive air conditioner 2 would run counter to the occupant's request.

On the other hand, in the air conditioning operation OFF state (step S1403), if the occupant turns on the automotive air conditioner 2 by operating the A/C operation panel 59, the operation level determining unit 68 causes the automotive air conditioner 2 to start the air conditioning operation. The automotive air conditioner 2 thus moves to the air conditioning operation forceful ON state (step S1406).

In the air conditioning operation forceful ON state (step S1406), if the occupant turns off the automotive air conditioner 2 by operating the A/C operation panel 59, the operation level determining unit 68 causes the automotive air conditioner 2 to stop the air conditioning operation. The automotive air conditioner 2 thus moves to the air conditioning operation OFF resume state (step S1407). When a predetermined time (for example, one minute) has elapsed from the start of the air conditioning operation OFF resume state (step S1407), the operation level determining unit 68 automatically causes the automotive air conditioner 2 to move to the air conditioning operation OFF state (step S1403). However, if the occupant turns on the automotive air conditioner 2 by operating the A/C operation panel 59 before the predetermined time elapses from the start of the air conditioning operation OFF resume state (step S1407), the operation level determining unit 68 causes the automotive air conditioner 2 to start the air conditioning operation. The automotive air conditioner 2 thus moves back to the air conditioning operation forceful ON state (step S1406).

When the automotive air conditioner 2 is in the air conditioning operation OFF resume state, if the discomfort degree exceeds the threshold value ThIRp, the operation level determining unit 68 will not start the air conditioning operation of the automotive air conditioner 2 (that is, the automotive air conditioner 2 will not move to the air conditioning operation ON state). This is because the automotive air conditioner 2 being put in the air conditioning operation OFF resume state means that the air conditioning operation has just been stopped in accordance with the occupant's request, and therefore, automatically resuming the air conditioning operation of the automotive air conditioner 2 would run counter to the occupant's request.

In this way, when the automotive air conditioner 2 is set in the eco-operation mode, the automotive air conditioner 2 is in one of the states defined in the above steps S1402 to 1407. When the automotive air conditioner 2 is in any one of the states defined in the above steps S1402 to 1407, if the automotive air conditioner 2 is set to the normal operation mode by the YES/NO switch 75, the operation level determining unit 68 terminates the eco-operation mode.

When the automotive air conditioner 2 is in the air conditioning operation ON state (step S1402), the operation level determining unit 68 may automatically cause the automotive air conditioner 2 to move to the air conditioning operation OFF state (step S1403) when a predetermined time (for example, three minutes) has elapsed from the start of the air conditioning operation.

The discomfort degree estimation model correcting unit 69 corrects the discomfort degree estimation model so as to match the occupant's sensitivity to temperature.

To correct the discomfort degree estimation model, the discomfort degree estimation model correcting unit 69 acquires the temperature IR_{d} around the occupant and the amount of temperature change ΔIR_{d} at periodic intervals of time (for example, every 10 seconds) when the eco-operation mode is ON. The amount of temperature change ΔIR_{d} here represents the absolute difference between the temperature around the occupant acquired when the air conditioning operation state of the automotive air conditioner 2 was last changed and the most recently acquired temperature around the occupant. The discomfort degree estimation model correcting unit 69 stores them in the temporary storage area 61a formed from a ring buffer, by associating them with a weighting coefficient and a discomfort label indicating that the occupant is feeling uncomfortable or a comfort label indicating that the occupant is feeling comfortable. As will be described later, the temporary storage area 61a has a storage capacity sufficient to store the temperature IR_{d} and the amount of temperature change ΔIR_{d} acquired over a period (for example, three minutes) longer than the period during which the label may be corrected, and their associated labels and weight coefficients. When the automotive air conditioner 2 is operated by the occupant, the discomfort degree estimation model correcting unit 69 corrects, in accordance with the operation, the labels and weight coefficients associated with the temperature IR_{d} and the amount of temperature change ΔIR_{d} stored in the temporary storage area 61a. When data has been stored up to the capacity of the temporary storage area 61a, the oldest data is discarded when storing new data. Therefore, each time the temperature IR_{d} and the amount of temperature change ΔIR_{d} are newly acquired, the oldest temperature IR_{d} and the oldest amount of temperature change ΔIR_{d} stored in the temporary storage area 61a are transferred together with their associated label and weighting coefficient to the storage unit 61 and stored therein as learned data.

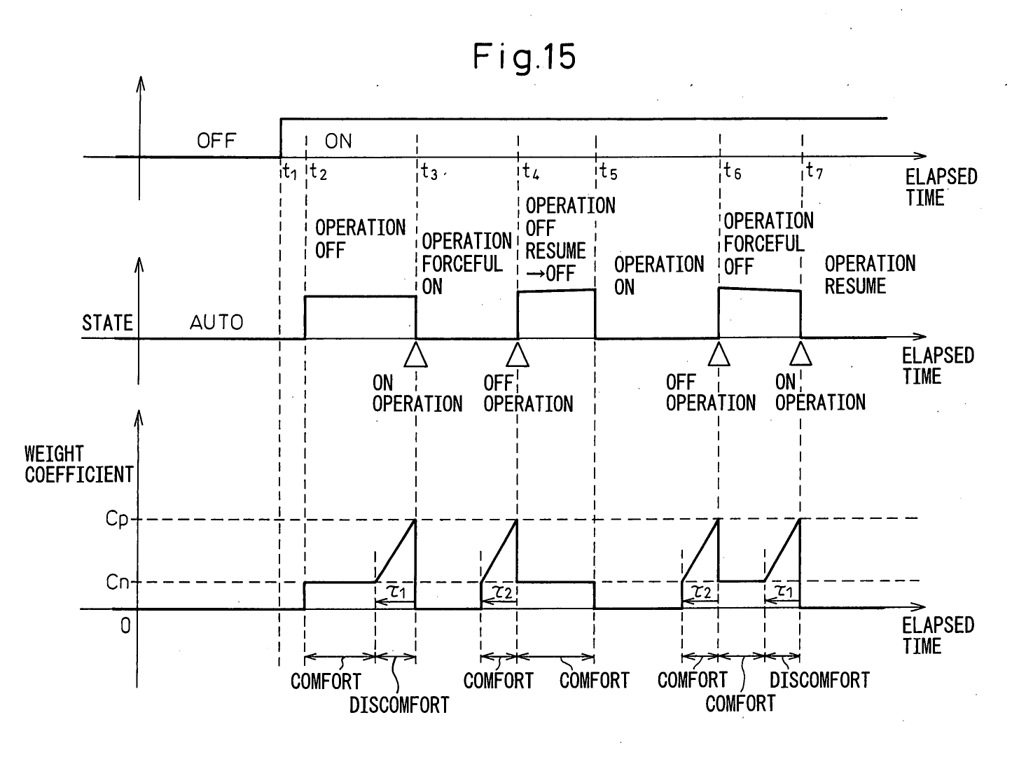

The correspondence between the temperature IR_{d} and the amount of temperature change ΔIR_{d} (hereinafter referred to as the learned data) and the label associated with the learned data will be described below with reference to FIG. 15. The timing charts shown in FIG. 15 illustrate, from top to bottom, the ON/OFF state of the eco-operation mode, the operation state of the automotive air conditioner 2, and the weight coefficient and label associated with the learned data. In each timing chart, the abscissa represents the elapsed time.

At time t₁, the automotive air conditioner 2 is set to the eco-operation mode. After that, at time t₂, the automotive air conditioner 2 is put in the air conditioning operation OFF state by the operation level determining unit 68. The learned data acquired after time t₂ is stored in the temporary storage area 61a formed from a ring buffer. Here, when the automotive air conditioner 2 is in the air conditioning operation OFF state, it is believed that the discomfort degree is low. This is because the operation level determining unit 68 causes the automotive air conditioner 2 to move to the air conditioning operation OFF state when the temperature IR_{d} has dropped to a relatively low level (that is, when it is presumed that the discomfort level has dropped to a relatively low level), as earlier described. Accordingly, the discomfort degree estimation model correcting unit 69 appends to any learned data acquired after time t₂ a comfort label indicating that the occupant is feeling comfortable. Further, the discomfort degree estimation model correcting unit 69 assigns a relatively small weighting coefficient Cn (for example, 1) to such learned data.

Next, suppose that, at time t₃, the occupant turned on the automotive air conditioner 2 by operating the A/C operation panel 59, thus causing the automotive air conditioner 2 to move to the air conditioning operation forceful ON state. It is presumed that, at or near time t₃, the occupant is feeling rather uncomfortable. Therefore, the discomfort degree estimation model correcting unit 69 changes the label appended to any learned data acquired during a predetermined period τ₁ (for example, 60 seconds) immediately preceding time t₃ to the discomfort label. Further, the discomfort degree estimation model correcting unit 69 assigns a relatively large weighting coefficient Cp (for example, 100) to the learned data acquired at time t₃. Furthermore, the discomfort degree estimation model correcting unit 69 sets the weighting coefficient assigned to the learned data acquired during the interval between time (t₃−τ₁) and time t₃ so that the weighting coefficient decreases into the past from time t₃ and becomes equal to Cn at time (t₃−τ₁).

On the other hand, the discomfort degree estimation model correcting unit 69 assigns a weight of 0 to any data acquired after time t₃. Alternatively, the discomfort degree estimation model correcting unit 69 may set the weight of any data acquired after time t₃ to Cn and append a discomfort label to it.

Next, suppose that, at time t₄, the occupant turned off the automotive air conditioner 2 by operating the A/C operation panel 59, thus causing the automotive air conditioner 2 to move to the air conditioning operation OFF resume state. It is presumed that, at or near time t₄, the occupant is feeling rather comfortable. Therefore, the discomfort degree estimation model correcting unit 69 appends a comfort label to any learned data acquired during a predetermined period τ₂ (for example, 30 seconds) immediately preceding time t₄. Further, the discomfort degree estimation model correcting unit 69 assigns a weighting coefficient Cp to the learned data acquired at time t₄. Furthermore, the discomfort degree estimation model correcting unit 69 sets the weighting coefficient assigned to the learned data acquired during the interval between time (t₄−τ₂) and time t₄ so that the weighting coefficient decreases into the past from time t₄ and becomes equal to Cn at time (t₄−τ₂).

After that, the discomfort degree estimation model correcting unit 69 appends a comfort label to any learned data acquired when the automotive air conditioner 2 is in the air conditioning operation OFF resume state or the air conditioning operation OFF state. Further, the discomfort degree estimation model correcting unit 69 assigns a weighting coefficient Cn to such learned data.

Next, suppose that the automotive air conditioner 2 moved to the air conditioning operation ON state at time t₅; in this case, the discomfort degree estimation model correcting unit 69 assigns a weight of 0 to any data acquired after time t₅. Alternatively, the discomfort degree estimation model correcting unit 69 may set the weight of any data acquired after time t₅ to Cn and append a discomfort label to it.

Suppose that, at time t₆, the occupant turned off the automotive air conditioner 2 by operating the A/C operation panel 59, thus causing the automotive air conditioner 2 to move to the air conditioning operation forceful OFF state. It is presumed that, at or near time t₆, the occupant is feeling rather comfortable. Therefore, the discomfort degree estimation model correcting unit 69 appends a comfort label to any learned data acquired during a predetermined period τ₂ immediately preceding time t₆. Further, the discomfort degree estimation model correcting unit 69 assigns a weighting coefficient Cp to the learned data acquired at time t₆, just as it did at time t₄. Furthermore, the discomfort degree estimation model correcting unit 69 sets the weighting coefficient assigned to the learned data acquired during the interval between time (t₆−τ₂) and time t₆ so that the weighting coefficient decreases into the past from time t₆ and becomes equal to Cn at time (t₆−τ₂). After that, the discomfort degree estimation model correcting unit 69 appends a comfort label to any learned data acquired when the automotive air conditioner 2 is in the air conditioning operation forceful OFF state.

Finally, suppose that, at time t₇, the occupant turned on the automotive air conditioner 2 by operating the A/C operation panel 59, thus causing the automotive air conditioner 2 to move to the air conditioning operation resume state. It is presumed that, at or near time t₇, the occupant is feeling rather uncomfortable. Therefore, the discomfort degree estimation model correcting unit 69 changes the label appended to any learned data acquired during a predetermined period τ₁ immediately preceding time t₇ to the discomfort label. Further, the discomfort degree estimation model correcting unit 69 assigns a weighting coefficient Cp to the learned data acquired at time t₇. Furthermore, the discomfort degree estimation model correcting unit 69 sets the weighting coefficient assigned to the learned data acquired during the interval between time (t₇−τ₁) and time t₇ so that the weighting coefficient decreases into the past from time t₇ and becomes equal to Cn at time (t₇−τ₁).

The discomfort degree estimation model correcting unit 69 corrects the discomfort degree estimation model periodically (for example, each time the vehicle engine is stopped) by using the learned data accumulated in the storage unit 61. More specifically, the discomfort degree estimation model correcting unit 69 corrects the CPT of the output node of the discomfort degree estimation model. For example, the discomfort degree estimation model correcting unit 69 calculates, using the following equation, the discomfort degree PIR_{Feel} (IR_{d}, ΔIR_{d}) for the set of the values of the temperature and the amount of temperature change (IR_{d}, ΔIR_{d}) accumulated as the learned data.

$${PIR}_{Feel} ( {IR}_{d} , Δ {IR}_{d} ) = \frac{\sum {C}_{d} ( {IR}_{d} , Δ {IR}_{d} )}{\sum {C}_{c} ( {IR}_{d} , Δ {IR}_{d} ) + \sum {C}_{d} ( {IR}_{d} , Δ {IR}_{d} )} \qquad ( 5 )$$

Here, ΣC_{c}(IR_{d}, ΔIR_{d}) represents the sum of the weighting coefficients assigned to the set of the values of the temperature and the amount of temperature change (IR_{d}, ΔIR_{d}) to which the comfort label has been appended. On the other hand, ΣC_{d}(IR_{d}, ΔIR_{d}) represents the sum of the weighting coefficients assigned to the set of the values of the temperature and the amount of temperature change (IR_{d}, ΔIR_{d}) to which the discomfort label has been appended. The comfort degree for each value of the set of the temperature and the amount of temperature change (IR_{d}, ΔIR_{d}) is given as (1−PIR_{Feel}(IR_{d}, ΔIR_{d})), as earlier described.

Here, the discomfort degree estimation model correcting unit 69 may correct the CPT of the output node of the discomfort degree estimation model only for the set of the values of the temperature and the amount of temperature change (IR_{d}, ΔIR_{d}) falling within a predefined range. By thus limiting the range of the values of the temperature and the amount of temperature change that can be used to correct the discomfort degree estimation model, the discomfort degree estimation model correcting unit 69 can be prevented from excessively learning the discomfort degree estimation model. For example, in the CPT 1213 of the discomfort degree estimation model 1200 shown in FIG. 12, the likelihood that the occupant feels uncomfortable is extremely high, whoever the occupant is, for the class where the temperature IR_{d} is 31° C. to 32° C. and the amount of temperature change ΔIR_{d} is 4° C. to 5° C. and for the class where the temperature IR_{d} is higher than 32° C. and the amount of temperature change ΔIR_{d} is 2° C. to 3° C. Therefore, the discomfort degree estimation model correcting unit 69 does not correct the CPT 1213 for these classes. Likewise, for classes such as the class where the temperature IR_{d} is not higher than 27° C. and the amount of temperature change ΔIR_{d} is 1° C. to 2° C., the likelihood that the occupant feels comfortable is extremely high, whoever the occupant is. Therefore, the discomfort degree estimation model correcting unit 69 does not correct the CPT 1213 for such classes.

On the other hand, for classes such as the class where the temperature IR_{d} is 29° C. to 30° C. and the amount of temperature change ΔIR_{d} is 2° C. to 3° C., it is highly likely that the degree of comfort or discomfort that the occupant feels differ depending on the occupant. Accordingly, the discomfort degree estimation model correcting unit 69 corrects the CPT 1213 for any class corresponding to the set of the values of the temperature and the amount of temperature where different occupants are likely to feel differently.

Further, before proceeding to the calculation of the above equation (5), the discomfort degree estimation model correcting unit 69 may apply filtering to ΣC_{c}(IR_{d}, ΔIR_{d}) and ΣC_{d}(IR_{d}, ΔIR_{d}) by using a smoothing filter such as a Gaussian filter. When a large number of learned data are accumulated for a given set of the values of the temperature and the amount of temperature change (IR_{d}, ΔIR_{d}), the discomfort degree estimation model correcting unit 69 can efficiently correct the discomfort degree estimation model by applying the filtering, since the CPT of the output node can also be corrected for the class corresponding to the set of values surrounding that given set of values. In this case, for τC_{c}(IR_{d}, ΔIR_{d}) which represents the sum of the weighting coefficients assigned to the set of the values of the temperature and the amount of temperature change to which the comfort label has been appended, the discomfort degree estimation model correcting unit 69 may apply smoothing only in the direction in which the occupant feels more comfortable (in the case of cooling operation, in the direction in which the IR_{d} and ΔIR_{d} decrease). Similarly, for ΣC_{d}(IR_{d}, ΔIR_{d}) which represents the sum of the weighting coefficients assigned to the set of the values of the temperature and the amount of temperature change to which the discomfort label has been appended, the discomfort degree estimation model correcting unit 69 may apply smoothing only in the direction in which the occupant feels more uncomfortable (in the case of cooling operation, in the direction in which the IR_{d} and ΔIR_{d} increase).

As described above, the automotive air conditioner 2 according to the second embodiment of the present invention estimates the discomfort degree that indicates the degree to which the occupant of the passenger compartment feels uncomfortable, and automatically stops the air conditioning operation when the discomfort degree decreases. Accordingly, the automotive air conditioner 2 can prevent the passenger compartment from being excessively cooled or heated, and can thus improve fuel economy. On the other hand, when the discomfort degree increases, the automotive air conditioner 2 automatically starts the air conditioning operation to keep the passenger compartment comfortable for the passenger.

The automotive air conditioner 2 according to the second embodiment of the present invention also is not limited to the above embodiment. For example, the operation level determining unit 68 may adjust the degree of the air conditioning operation according to the discomfort degree. For example, when the discomfort degree PIR_{d} exceeds the threshold value ThIRp, the operation level determining unit 68 increases the degree of the air conditioning operation. When a predetermined time has elapsed after the degree of the air conditioning operation was increased, or when the temperature IR_{d} has dropped to the air conditioning stopping temperature IRCn or lower (at the time of cooling) or increased to the air conditioning stopping temperature IRCn or higher (at the time of heating), the operation level determining unit 68 reduces the degree of the air conditioning operation.

Here, reducing the degree of the air conditioning operation includes not only stopping the air conditioning operation, but also increasing the set temperature for cooling or reducing the rotational speed of the blower fan (that is, reducing the amount of conditioned air to be discharged from the air outlets). On the other hand, increasing the degree of the air conditioning operation includes not only starting the air conditioning operation, but also lowering the set temperature for cooling or increasing the rotational speed of the blower fan.

As a criterion for determining whether to stop the air conditioning operation or whether to reduce the degree of the air conditioning operation, the discomfort degree estimating unit 67 may use the discomfort degree that would be obtained after a predetermined time (for example, five minutes) if the air conditioning operation were stopped or the degree of the air conditioning operation were reduced (the discomfort degree expected to be obtained after the predetermined time is hereinafter called the future discomfort degree). In this case, the operation level determining unit 68 may perform control so as to stop the air conditioning operation or reduce the degree of the air conditioning operation if the future discomfort degree does not exceed the threshold value ThIRp. The discomfort degree estimating unit 67 can calculate the future discomfort degree by using a probabilistic model similar to the discomfort degree estimation model. In this case, however, the output node of the probabilistic model outputs the probability that the occupant would feel uncomfortable or comfortable after the predetermined time if the air conditioning operation were stopped. The probability that the occupant would feel uncomfortable may be taken as the future discomfort degree. Alternatively, the discomfort degree estimating unit 67 may determine whether the air conditioning state of the passenger compartment to be achieved after the predetermined time satisfies the comfort condition, by performing processing similar to the processing performed by the air conditioning state estimating unit 63 and the recommended operation determining unit 64 in the first embodiment of the present invention. In this case, when it is determined that the air conditioning state satisfies the comfort condition, the discomfort degree estimating unit 67 can stop the air conditioning operation of the automotive air conditioner 2 or reduce the degree of the air conditioning operation.

The present invention can be applied to an air conditioner of any type, whether it be a front single type, a left/right independent type, a rear independent type, a four-seat independent type, or an upper/lower independent type. When applying the present invention to an air conditioner of an independent type, a plurality of inside temperature sensors and solar sensors may be mounted.

As described above, various modifications can be made within the scope of the present invention.

What is claimed is:

1. An automotive air conditioner comprising:
an air-conditioning unit for supplying conditioned air into a passenger compartment of a vehicle;
an information acquiring unit for acquiring state information indicating a state relating to said vehicle;
an air conditioning state estimating unit for estimating an air conditioning state inside said passenger compartment that would be achieved after a predetermined time if a setting operation for improving fuel economy were performed based on said state information;
a recommended operation determining unit for recommending said setting operation if it is determined that said estimated air conditioning state satisfies a comfort condition that would make said passenger compartment comfortable for an occupant; and,
an air-conditioning control unit for controlling said air-conditioning unit in accordance with said recommended setting operation.

2. The automotive air conditioner according to claim 1, further comprising:
a display unit for presenting said recommended setting operation to said occupant; and
a decision input unit for entering a decision as to whether to approve or not approve said recommended setting operation, and wherein
when an approval operation for approving said recommended setting operation is performed via said decision input unit, said air-conditioning control unit controls said air-conditioning unit in accordance with said recommended setting operation.

3. The automotive air conditioner according to claim 1, wherein said comfort condition is given as a comfortable temperature probability distribution relating to a passenger compartment temperature that said occupant feels comfortable, and wherein
said air conditioning state estimating unit obtains said estimated air conditioning state as an estimated temperature probability distribution relating to the passenger compartment temperature that would be achieved after said predetermined time, and
said recommended operation determining unit obtains a separation between said comfortable temperature probability distribution and said estimated temperature probability distribution, and determines that said estimated air conditioning state satisfies said comfort condition if said separation is not larger than a predetermined threshold value.

4. The automotive air conditioner according to claim 3, wherein said recommended operation determining unit determines said comfortable temperature probability distribution by using a probabilistic model that takes said state information as an input and that outputs the probability distribution relating to the passenger compartment temperature that said occupant feels comfortable.

5. The automotive air conditioner according to claim 4, further comprising:
a storage unit for storing, as a set of learned data, a plurality of pieces of state information acquired by said information acquiring unit when in a stable state; and
a comfort condition determining unit for generating or updating said probabilistic model by using said set of learned data.

6. The automotive air conditioner according to claim 1, wherein said state information is an estimated time required to reach a destination, and said fuel economy improving setting operation is an operation for stopping said air-conditioning unit or for bringing a set temperature closer to a temperature outside said vehicle.

7. The automotive air conditioner according to claim 6, wherein said air conditioning state estimating unit obtains as said estimated air conditioning state a passenger compartment temperature that would be achieved after said estimated required time, and
said recommended operation determining unit determines that said estimated air conditioning state satisfies said comfort condition if the passenger compartment temperature that would be achieved after said estimated required time falls within a prescribed temperature range.

8. The automotive air conditioner according to claim 7, wherein said recommended operation determining unit obtains a probability concerning the passenger compartment temperature that said occupant feels comfortable by using a probabilistic model that takes said state information as an input, and determines said prescribed temperature range by taking a temperature range where said probability becomes the highest.

9. The automotive air conditioner according to claim 1, wherein said state information is a passenger compartment temperature, and said fuel economy improving setting operation is an operation for stopping said air-conditioning unit or for bringing a set temperature closer to a temperature outside said vehicle.

10. The automotive air conditioner according to claim 9, wherein said air conditioning state estimating unit obtains as said estimated air conditioning state the passenger compartment temperature that would be achieved after said predetermined time, and
said recommended operation determining unit determines that said estimated air conditioning state satisfies said comfort condition if the passenger compartment temperature that would be achieved after said predetermined time falls within a prescribed temperature range.

11. The automotive air conditioner according to claim 10, wherein said recommended operation determining unit obtains a probability concerning the passenger compartment temperature that said occupant feels comfortable by using a probabilistic model that takes said state information as an input, and determines said prescribed temperature range by taking a temperature range where said probability becomes the highest.

12. A method for controlling an automotive air conditioner having an air-conditioning unit for supplying conditioned air into a passenger compartment of a vehicle, comprising;
acquiring state information indicating a state relating to said vehicle;
estimating an air conditioning state inside said passenger compartment that would be achieved after a predetermined time if a setting operation for improving fuel economy were performed based on said state information;
recommending said setting operation if it is determined that said estimated air conditioning state satisfies a comfort condition that would make said passenger compartment comfortable for an occupant; and
controlling said air-conditioning unit in accordance with said recommended setting operation.

13. An automotive air conditioner comprising:
an air-conditioning unit for supplying conditioned air into a passenger compartment of a vehicle;
an information acquiring unit for acquiring at least one kind of state information indicating a state inside said passenger compartment;
a discomfort degree estimating unit for estimating a discomfort degree by using a probabilistic model that takes said at least one kind of state information as an input and that outputs said discomfort degree representing the degree to which an occupant feels uncomfortable;
an operation level determining unit for determining an operation level so as to increase the degree of air conditioning if said discomfort degree exceeds a first reference value; and
an air-conditioning control unit for controlling said air-conditioning unit in accordance with the degree of air conditioning determined by said operation level determining unit.

14. The automotive air conditioner according to claim 13, further comprising:
an operation unit for regulating the degree of air conditioning;
a storage unit for storing said at least one kind of state information as uncomfortable state data corresponding to a state that said occupant feels uncomfortable each time an operation for increasing the degree of air conditioning is performed via said operation unit; and
a discomfort degree estimation model correcting unit for correcting said probabilistic model in such a manner that the discomfort degree associated with the value of said at least one kind of state information increases as the number of pieces of said uncomfortable state data associated with said value increases.

15. The automotive air conditioner according to claim 14, wherein said storage unit stores said at least one kind of state information as comfortable state data corresponding to a state that said occupant feels comfortable each time an operation for reducing the degree of air conditioning is performed via said operation unit, and
said discomfort degree estimation model correcting unit corrects said probabilistic model in such a manner that the discomfort degree associated with the value of said at least one kind of state information decreases as the number of pieces of said comfortable state data associated with said value increases.

16. The automotive air conditioner according to claim 14, wherein said discomfort degree estimation model correcting unit corrects said probabilistic model in such a manner as to change only the discomfort degree associated with the value of said at least one kind of state information that falls within a predetermined range.

17. The automotive air conditioner according to claim 13, wherein said information acquiring unit is a far-infrared sensor, and
said at least one kind of state information includes a temperature around said occupant which is estimated by said information acquiring unit.

18. The automotive air conditioner according to claim 13, wherein said operation level determining unit determines said operation level so as to reduce the degree of air conditioning if said discomfort degree decreases to or below a second reference value which is lower than said first reference value.

19. The automotive air conditioner according to claim 13, wherein said discomfort degree estimating unit estimates the discomfort degree that said occupant would feel after a predetermined time if an operation for reducing the degree of air conditioning were performed based on said at least one kind of state information, and said operation level determining unit determines said operation level so as to reduce the degree of air conditioning if the discomfort degree that said occupant would feel after said predetermined time does not exceed said first reference value.

20. A method for controlling an automotive air conditioner having an air-conditioning unit for supplying conditioned air into a passenger compartment of a vehicle, comprising:
acquiring at least one kind of state information indicating a state inside said passenger compartment;
estimating a discomfort degree by using a probabilistic model that takes said at least one kind of state information as an input and that outputs said discomfort degree representing the degree to which an occupant feels uncomfortable;
determining an operation level so as to increase the degree of air conditioning if said discomfort degree exceeds a first reference value; and
controlling said air-conditioning unit in accordance with said determined degree of air conditioning.

21. The control method according to claim 20, further comprising determining said operation level so as to reduce the degree of air conditioning if said discomfort degree decreases to or below a second reference value which is lower than said first reference value.

22. The control method according to claim 20, further comprising:
estimating the discomfort degree that said occupant would feel after a predetermined time if an operation for reducing the degree of air conditioning were performed based on said at least one kind of state information; and
determining said operation level so as to reduce the degree of air conditioning if the discomfort degree that said occupant would feel after said predetermined time does not exceed said first reference value.
